(19) United States
(12) Patent Application Publication
(10) Pub. No.: US 2018/0346337 A1
(43) Pub. Date: Dec. 6, 2018

(54) FORMATION OF THREE-DIMENSIONAL MATERIALS BY COMBINING CATALYTIC AND PRECURSOR MATERIALS

(71) Applicants: William Marsh Rice University, Houston, TX (US); Tianjin University, Nankai District, Tianjin (CN)

(72) Inventors: James M. Tour, Bellaire, TX (US); Junwei Sha, Dongli District, Tianjin (CN); Naiqin Zhao, Nankai District, Tianjin (CN)

(73) Assignees: William Marsh Rice University, Houston, TX (US); Tianjin University, Nankai District, Tianjin (CN)

(21) Appl. No.: 15/779,152

(22) PCT Filed: Nov. 25, 2016
(86) PCT No.: PCT/US2016/063776

§ 371 Date: May 25, 2018

Related U.S. Application Data
(60) Provisional application No. 62/260,127, filed on Nov. 25, 2015.

(51) Int. Cl. C01B 32/184; H01M 4/66; H01M 4/80; H01M 4/96; H01M 4/86; C25B 11/12; H01G 11/36

(52) U.S. Cl. CPC C01B 32/184; H01M 4/663; H01M 4/666; H01M 4/808; B82Y 30/00; H01M 4/8621; C25B 11/12; H01G 11/36; H01M 4/96

(57) ABSTRACT

Embodiments of the present disclosure pertain to methods of making three-dimensional materials by combining a catalytic material with a precursor material and forming the three-dimensional material from the precursor material in the presence of the catalytic material. The three-dimensional material may be formed on surfaces and internal cavities of the catalytic material. The formed three-dimensional material includes a plurality of connected units that are derived from the precursor materials. The methods of the present disclosure may also include steps of separating catalytic materials from the formed three-dimensional materials and incorporating the three-dimensional materials as a component of an energy storage device (e.g., as an electrode in a capacitor). Additional embodiments of the present disclosure pertain to the formed three-dimensional materials.

### CROSS-REFERENCE TO RELATED APPLICATIONS

This application claims priority to U.S. Provisional Patent Application No. 62/260,127, filed on Nov. 25, 2015. The entirety of the aforementioned application is incorporated herein by reference.

### STATEMENT REGARDING FEDERALLY SPONSORED RESEARCH

This invention was made with government support under Grant No. FA9550-12-1-0035, awarded by the U.S. Department of Defense. The government has certain rights in the invention.

### BACKGROUND

Current methods of making three-dimensional materials suffer from numerous limitations, including limited scalability and multiple steps. Furthermore, current three-dimensional materials suffer from numerous limitations, including limited surface areas, defective structures, limited conductivity, and limited structural stability. Various aspects of the present disclosure address the aforementioned limitations.

### SUMMARY

In some embodiments, the present disclosure pertains to methods of making three-dimensional materials by combining a catalytic material with a precursor material and forming the three-dimensional material from the precursor material in the presence of the catalytic material. In some embodiments, the three-dimensional material is formed on surfaces and internal cavities of the catalytic material. In some embodiments, the formed three-dimensional material includes a plurality of connected units.

In some embodiments, the precursor material includes, without limitation, carbon sources, non-carbon sources, metal sources, chalcogenide sources, metal chalcogenide sources, boron containing compounds, nitrogen containing compounds, carbon nanotubes, graphene nanoribbons, boron nitride nanotubes, chalcogenide nanotubes, metal chalcogenide nanotubes, nanoparticles, nanorods, nanowires, carbon onions, solid precursor materials, liquid precursor materials, gaseous precursor materials, and combinations thereof. In some embodiments, the precursor material includes a carbon source (e.g., sucrose) and carbon nanotubes (e.g., multi-walled carbon nanotubes).

In some embodiments, the formation of three-dimensional materials from precursor materials includes connecting the precursor materials to one another. In some embodiments, the formation of three-dimensional materials from the precursor materials includes growing the three-dimensional materials from the precursor materials. In some embodiments, the formation of the three-dimensional materials from the precursor materials includes heating the precursor materials in the presence of the catalytic materials.

The three-dimensional materials of the present disclosure can include various types of connected units. For instance, in some embodiments, the connected units include, without limitation, graphene, carbon shells, phosphorenes, boron nitrides, metal layers, connected precursor materials, hybrid materials thereof, composites thereof, and combinations thereof.

In some embodiments, the connected units of the three-dimensional materials include hybrid materials, such as graphene hybrid materials. In some embodiments, the graphene hybrid materials include, without limitation, graphene-carbon nanotube hybrid materials, graphene-carbon onion hybrid materials, graphene-carbon shell hybrid materials, graphene-boron nitride hybrid materials, graphene-carbon nanotube-carbon shell hybrid materials, graphene-boron nitride nanotube-carbon shell hybrid materials, and combinations thereof. In some embodiments, the graphene hybrid materials include graphene-carbon nanotube-carbon shell hybrid materials.

In some embodiments, the methods of the present disclosure also include a step of separating the catalytic material from the formed three-dimensional material. In some embodiments, the separation occurs by etching.

In some embodiments, the methods of the present disclosure also include a step of incorporating the formed three-dimensional materials as a component of an energy storage device. For instance, in some embodiments, the formed three-dimensional material may be utilized as an electrode in an energy storage device, such as a capacitor. Additional embodiments of the present disclosure pertain to the formed three-dimensional materials.

### FIGURES

FIG. 1 provides a scheme of a method of making a three-dimensional material (FIG. 1A) and an illustration of the formed three-dimensional material (FIG. 1B).

FIG. 2 provides a scheme of a powder metallurgy-chemical method to prepare a three-dimensional graphene foam (3D PMT-GF).

FIG. 3 provides Raman spectra of 3D PMT-GFs using nickel (Ni) and copper (Cu) as templates.

FIG. 4 provides images of the prepared 3D PMT-GFs, including scanning electron microscopy (SEM) images (FIGS. 4A-B) and transmission electron microscopy (TEM) images (FIGS. 4C-D).

FIG. 5 provides digital photos of 3D PMT-GFs before and after loading different weights.

FIG. 6 provides SEM images of 3D PMT-GFs before (FIGS. 6A-B) and after (FIGS. 6C-D) loading with a 50 g weight for 30 seconds.

FIG. 7 provides various data relating to the characterization of 3D PMT-GFs, including their N₂ adsorption-desorption isotherms (FIG. 7A) and pore size distributions (FIG. 7B).

FIG. 8 provides additional data relating to the characterization of 3D PMT-GFs, including their Raman spectra (FIG. 8A), X-ray diffraction (XRD) pattern (FIG. 8B), thermogravimetric analysis (TGA) (FIG. 8C), and X-ray photoelectron spectroscopy (XPS) data (FIG. 8D).

FIG. 9 provides XPS data of 3D PMT-GFs after further purification by heat-treatment at 800° C. for 2 hours in Argon (Ar).

FIG. 10 provides a schematic diagram of electrical conductivity testing (FIG. 10A) and a current-voltage curve (I vs V) in semi-logarithmic scale (FIG. 10B) for 3D PMT-GFs. The inset shows the linear scale current-voltage.

FIG. 11 provides a scheme of a powder metallurgy-chemical method to prepare three-dimensional rebar graphene foams containing multi-walled carbon nanotubes (3D rebar GF) (FIG. 11A), a schematic of tuning the shape of the pellet to prepare 3D rebar GF into a screw shape (FIG. 11B), and a photograph of an all-carbon 3D rebar GF screw with 18 wt % multi-walled carbon nanotubes (MWCNTs) (3D rebar GF-18) (FIG. 11C).

FIG. 12 provides comparative photographs of 3D PMT-GFs (FIG. 12A) and 3D rebar GFs (FIG. 12B).

FIG. 13 provides various images of 3D rebar-10 GFs, including SEM images (FIGS. 13A-D, where the scale bar of the inset image in FIG. 13D is 500 nm, and where the MWCNTs that are partially connected to the graphene sheet are marked by a yellow arrow); low magnification TEM image of 3D rebar-10 GF (FIG. 13E, where the inset is a selected area electron diffraction (SAED) pattern of 3D rebar-10 GF); high magnification TEM image showing the few-layer graphene structure (FIG. 13F); and TEM images highlighting the rebar connection (FIGS. 13G-H, where graphene is marked in blue and the MWCNT is marked in orange).

FIG. 14 provides additional SEM images of as-prepared 3D rebar-10 GF (FIGS. 14A-C).

FIG. 15 provides SEM images (FIG. 15A-C) and TEM images (FIG. 15D-F) of three-dimensional rebar graphene foams containing boron nitride nanotubes (3D BN rebar-2 GF).

FIG. 16 provides Raman spectra of as-prepared 3D rebar GFs, 3D PMT-GFs, and MWCNTs (FIG. 16A); TGA curves of 3D PMT-GF, 3D rebar-10 GF, and MWCNTs (FIG. 16B); XRD pattern of 3D rebar-10 GF (FIG. 16C); and XPS of 3D rebar-10 GF (FIG. 16D).

FIG. 17 provides various data relating to 3D rebar-10 GF, including N₂ adsorption-desorption isotherms (FIG. 17B), and pore size distribution (FIG. 17C).

FIG. 18 provides photographs of 3D rebar-18 GFs before and after loading different weights.

FIG. 19 provides additional data and photographs relating to 3D rebar GF. FIG. 19A shows photographs of 3D rebar-18 GFs before and after loading 540 g weights. FIG. 19B shows a photograph of a dynamic mechanical analysis (DMA) sample stage. FIG. 19C shows a maximum value of storage modulus of 3D PMT-GFs, 3D rebar-10 GFs, and 3D rebar-18 GFs during testing. FIG. 19D shows the average storage modulus and porosity of 3D GFs, 3D rebar-10 GFs, and 3D rebar-18 GFs. FIG. 19E shows the storage modulus of 3D rebar-10 GFs by re-testing the same sample after resting 24 hours.

FIG. 20 shows photographs of 3D rebar-18 GFs before (FIG. 20A), during (FIGS. 20B-C), and after (FIG. 20D) loading 198 g weight (the same scale on the ruler is marked with a black spot).

FIG. 21 shows SEM images of 3D rebar-10 GF (FIG. 21A), 3D rebar-18 GF (FIG. 21B), and raw MWCNTs (FIG. 21C).

FIG. 22 shows an average loss modulus of 3D PMT-GFs, 3D rebar-10 GFs, and 3D rebar-18 GFs.

FIG. 23 provides data relating to the electrical conductivity testing of 3D rebar-10 GFs. FIG. 23A shows a schematic diagram, in which the scale bar in the photograph is 1 cm. Also shown are current-voltage curves (I vs V) in semilogarithmic (FIG. 23B) and linear (FIG. 23C) scales.

FIG. 24 provides data relating to the characterization and electrical conductivity testing of 3D BN rebar-2 GF. FIGS. 24A-E show XPS spectra of as-prepared 3D BN rebar-2 GF, including a survey spectrum (FIG. 24A), a C 1 s spectrum (FIG. 24B), an O 1 s spectrum (FIG. 24C), a B is spectrum (FIG. 24D), and an N 1 s spectrum (FIG. 24E). FIG. 24F shows a schematic diagram in which the scale bar in the photograph is 1 cm. FIGS. 24G-H show current-voltage curves (I vs V) in semilogarithmic (FIG. 24G) and linear (FIG. 24H) scales.

FIG. 25 shows data and diagrams relating to the cross-plane electrical conductivity testing of thick 3D rebar-10 GF. FIG. 25A shows a schematic diagram of the experimental setup. FIGS. 25B-C show the current-voltage curves (I vs V) in semilogarithmic (FIG. 25B) and linear (FIG. 25C) scales.

FIG. 26 shows data and schemes relating to the testing of 3D rebar GFs as cathodes and anodes. FIG. 26A shows a scheme of a lithium-ion capacitor (LIC) during discharge with 3D rebar GFs as cathodes and anodes. FIG. 26B shows galvanostatic charge-discharge curves of the 3D rebar-10 GF tested between 0.01 and 3.0 V (anode half-cell test) at 0.1 A/g. FIG. 26C shows galvanostatic charge-discharge curves of the 3D rebar-10 GF tested between 1 and 4.3 V (cathode half-cell test) at 0.1 A g⁻¹. FIG. 26D shows galvanostatic charge-discharge curves (voltage vs time) of an LIC at different current densities (1.62, 3.25, 6.50, 13.0 and 19.2 mA cm⁻² equivalent to 0.025, 0.050, 0.10, 0.20 and 0.60 A g⁻¹, respectively). FIG. 26E shows a Ragone plot of 3D rebar-10 GF LIC. FIG. 26F shows the cycling stability of LIC tested at 6.50 mA cm⁻².

FIG. 27 shows the cycling stability of 3D rebar-10 GF half-cells as cathodes (FIG. 27A) and anodes (FIG. 27B) tested at 0.1 A g⁻¹.

FIG. 28 shows SEM images of three-dimensional graphene foams (3D GFs) that were produced by pressing the template pellets by hand (FIGS. 28A-C) and under 0.5 tons of pressure (FIGS. 28D-F).

FIG. 29 shows SEM images of 3D GFs that were produced by pressing the template pellets under 0.25 tons of pressure (FIGS. 29A-B) and under 6 tons of pressure (FIGS. 29C-D).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Three-dimensional materials find applications in numerous fields related to energy storage and mechanical dampening. The fabrication of three-dimensional materials generally involve the conversion of two-dimensional materials to three-dimensional materials.

For instance, graphene, a two-dimensional single-layer of carbon, has been used as electrodes for supercapacitors, lithium ion batteries, transparent conducting films, and catalytic systems. However, in energy storage device applications, individual two-dimensional graphene nanosheets should preferably be integrated into three-dimensional macroscopic structures in order to meet the mass and volume requirements of energy storage devices.

Several methods have been developed to prepare three-dimensional graphene. For instance, high quality three-dimensional graphene foam on nickel foam templates has been developed by chemical vapor deposition methods.

In addition, other templates such as sodium chloride and polystyrene colloidal particles have been used to fabricate three-dimensional graphene Likewise, self-assembly of graphene oxide by utilizing a hydrothermal process has been used to produce self-assembled three-dimensional graphene foams with enhanced mechanical strength.

In addition, carbon nanotubes have been used as reinforcement materials in various three-dimensional structures that include metals, polymers, and carbon matrix composites. For instance, the in situ synthesis of a carbon nanotube-reinforced aluminum matrix composite has been reported through a chemical vapor deposition process. Likewise, three-dimensional seamless structures of graphene and vertically aligned carbon nanotube carpets have been developed for use in energy storage and field-emission devices. Similarly, graphene has been grown in-plane with carbon nanotubes to result in the production of mechanically reinforced electrically conductive structures that have been referred to as rebar graphene.

However, the aforementioned methods and structures have numerous limitations. For instance, the aforementioned three-dimensional graphenes have demonstrated low degrees of crystallization, an inability to be free-standing, and low mechanical strength. Furthermore, the preparation of graphene oxide by conventional methods (e.g., Hummer or improved Hummers methods) are not facile. For instance, such methods use very strong and corrosive acids. Furthermore, the graphene foams formed from graphene oxide show large amounts of defects with poorly controlled pore structures. In addition, rebar graphene materials have limited applications due to a lack of an adequate three-dimensional structure.

Accordingly, more facile and scalable methods for preparing three-dimensional materials with high specific surface areas, high degrees of crystallization, high conductivity, and high structural stability are desired. Various aspects of the present disclosure address the aforementioned needs.

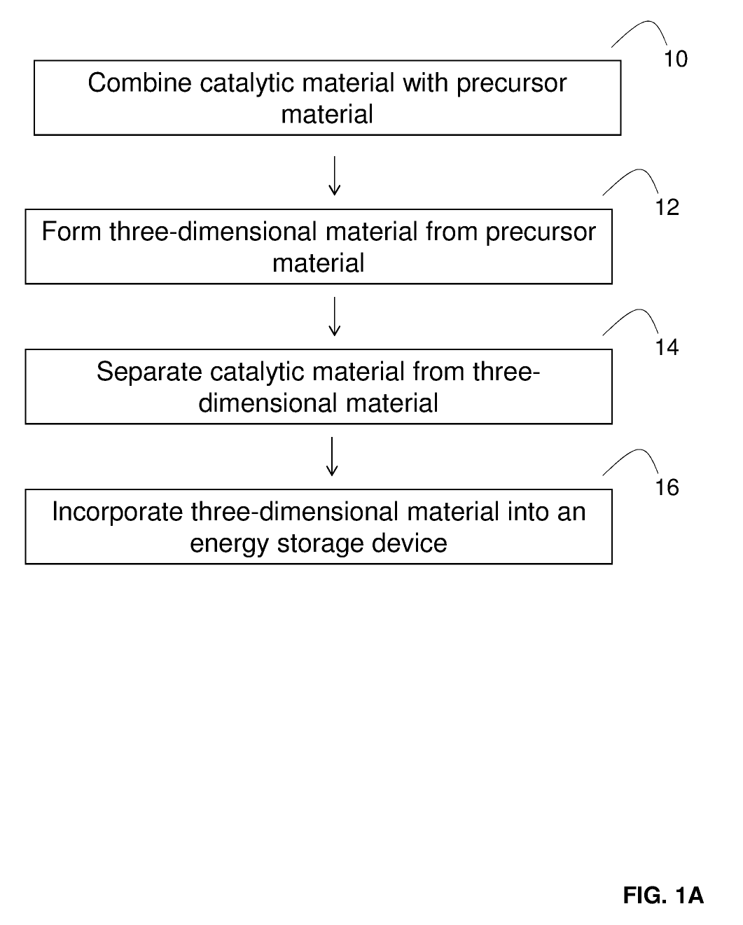

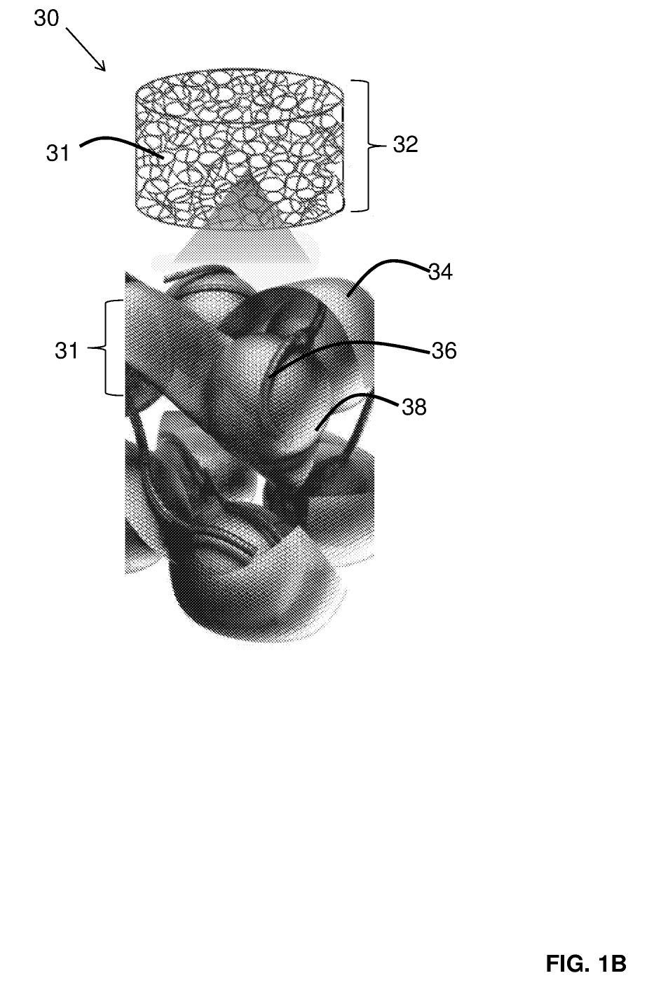

In some embodiments, the present disclosure pertains to methods of making three-dimensional materials. In some embodiments illustrated in FIG. 1A, the methods of the present disclosure include combining a catalytic material with a precursor material (step 10), and forming a three-dimensional material from the precursor material in the presence of the catalytic material (step 12). In some embodiments, the three-dimensional material forms on surfaces and internal cavities of the catalytic material. In some embodiments, the formed three-dimensional material includes a plurality of connected units.

In additional embodiments that are further illustrated in FIG. 1A, the methods of the present disclosure also include a step of separating the catalytic material from the formed three-dimensional material (step 14). In further embodiments, the methods of the present disclosure also include a step of incorporating the three-dimensional material as a component of an energy storage device (step 16).

Additional embodiments of the present disclosure pertain to the three-dimensional materials that are formed by the methods of the present disclosure, such as three-dimensional material 30 depicted in FIG. 1B. In particular, three-dimensional material 30 has a plurality of interconnected particles 31 that define a three-dimensional structure 32. In addition, particles 31 include a plurality of connected units 34, 36 and 38.

As set forth in more detail herein, the present disclosure can have various embodiments. In particular, various methods may be utilized to combine various catalytic materials with various precursor materials to form various three-dimensional materials that contain various types and arrangements of connected units. Various methods may also be utilized to separate catalytic materials from the formed three-dimensional materials. The formed three-dimensional materials may also be incorporated as components of various energy storage devices. Furthermore, various methods may be utilized to control the shape and porosity of the three-dimensional materials.

Catalytic Materials

The catalytic materials of the present disclosure can be used to mediate the formation of three-dimensional materials from precursor materials. The present disclosure may utilize various types of catalytic materials.

For instance, in some embodiments, the catalytic materials include, without limitation, Cu, Ni, Co, Fe, Pt, Au, Al, Ag, Cr, Mg, Mn, Mo, Rh, Ru, Si, Ta, Ti, W, U, V, Zr, powders thereof, foils thereof, vapor deposited metals thereof, reduced forms thereof, oxidized forms thereof, associated alloys thereof, and combinations thereof. In some embodiments, the catalytic materials include metal powders, such as nickel powders.

The catalytic materials of the present disclosure may include various shapes. For instance, in some embodiments, the catalytic materials of the present disclosure are in the shape of at least one of powders, skeletons, particles, pellets, shells, and combinations thereof.

In some embodiments, the catalytic materials of the present disclosure are in the form of skeletons, such as sintered metal skeletons. In more specific embodiments, the catalytic materials of the present disclosure are in the form of sintered nickel skeletons.

In some embodiments, the catalytic materials of the present disclosure are in the form of particles. In some embodiments, the particles include, without limitation, microparticles, nanoparticles, and combinations thereof. In some embodiments, the particle sizes range from about 100 nm to about 100 μm. In some embodiments, the particle sizes range from about 1 μm to about 5 μm. In some embodiments, the particle sizes range from about 2 μm to about 3.0 μm.

Precursor Materials

The precursor materials of the present disclosure generally serve as precursors to the connected units of the three-dimensional materials. Various precursor materials may be utilized in the present disclosure. For instance, in some embodiments, the precursor materials include, without limitation, carbon sources, non-carbon sources, metal sources, chalcogenide sources, metal chalcogenide sources, boron containing compounds, nitrogen containing compounds, carbon nanotubes, graphene nanoribbons, boron nitride nanotubes, chalcogenide nanotubes, metal chalcogenide nanotubes, nanoparticles, nanorods, nanowires, carbon onions, solid precursor materials, liquid precursor materials, gaseous precursor materials, and combinations thereof.

In some embodiments, the precursor materials of the present disclosure include carbon sources. In some embodiments, the carbon sources include, without limitation, alkanes, alkenes, alkylenes, alkynes, polymers, non-polymeric carbon sources, raw carbon sources, small molecules, organic compounds, carbohydrates, sugars, polysaccharides, carbon oxides, carbon nitride, carbon sulfides, lignin, asphalt, crude oil, bitumen, coke, coal, carbon nanotubes, graphene nanoribbons, graphene quantum dots, surfactants, and combinations thereof.

In some embodiments, the precursor materials of the present disclosure include a polymer. In some embodiments, the polymer includes, without limitation, poly(methyl methacrylate)s, polystyrenes, polyacrylonitriles, polycarbonates, poly(phenylene ethynylene)s, cellulose, poly(phenylene sulfide), and combinations thereof. In some embodiments, the precursor material includes poly(methyl methacrylate).

In some embodiments, the precursor materials of the present disclosure include a sugar. In some embodiments, the sugar includes, without limitation, sucrose, glucose, fructose, and combinations thereof. In some embodiments, the precursor material includes sucrose.

In some embodiments, the precursor materials of the present disclosure include carbon nanotubes. In some embodiments, the carbon nanotubes include, without limitation, functionalized carbon nanotubes, polymer wrapped carbon nanotubes, surfactant wrapped carbon nanotubes, metallic carbon nanotubes, semi-metallic carbon nanotubes, single-walled carbon nanotubes, double-walled carbon nanotubes, multi-walled carbon nanotubes, ultra-short carbon nanotubes, and combinations thereof. In some embodiments, the precursor materials of the present disclosure include multi-walled carbon nanotubes.

In some embodiments, the precursor materials of the present disclosure include boron nitride nanotubes. In some embodiments, the boron nitride nanotubes include, without limitation, functionalized boron nitride nanotubes, polymer wrapped boron nitride nanotubes, surfactant wrapped boron nitride nanotubes, un-functionalized boron nitride nanotubes, single-walled boron nitride nanotubes, multi-walled boron nitride nanotubes, and combinations thereof. In some embodiments, the precursor materials of the present disclosure include multi-walled boron nitride nanotubes.

In some embodiments, the precursor materials of the present disclosure include carbon onions. In some embodiments, the carbon onions include a metallic core and a carbon coating. In some embodiments, the metallic core includes one or more metals. In some embodiments, the metals include, without limitation, iron, nickel, cobalt, copper, magnesium, titanium, and combinations thereof. In some embodiments, the carbon coating includes, without limitation, graphene, fullerene, activated carbon, alkanes, polymers, and combinations thereof.

In some embodiments, the precursor materials of the present disclosure include chalcogenide nanotubes. In some embodiments, the chalcogenide nanotubes include, without limitation, metal monochalcogenide nanotubes, metal dichalcogenide nanotubes, metal trichalcogenide nanotubes, molybdenum disulfide (MoS₂) nanotubes, molybdenum trisulfide (MoS₃) nanotubes, titanium diselenide (TiSe₂) nanotubes, molybdenum diselenide (MoSe₂) nanotubes, tungsten diselenide (WSe₂) nanotubes, tungsten disulfide (WS₂) nanotubes, niobium triselenide (NbSe₃) nanotubes, and combinations thereof.

In some embodiments, the precursor materials of the present disclosure include a metal source. In some embodiments, the metal source includes, without limitation, Mo, W, Bi, Hf, Ga, Ge, Ta, Sn, Zn, Cd, Pb, B, Nb, Zr, hydrides thereof, oxides thereof, chalcogenides thereof, and combinations thereof. In some embodiments, the metal source includes metal hydrides, such as ammonia borane.

In some embodiments, the precursor materials of the present disclosure may be functionalized with a plurality of functional groups. In some embodiments, the functional groups include, without limitation, alkyl groups, alcohol groups, carboxyl groups, carbonyl groups, alkoxy groups, aryl groups, aryl sulfonyl groups, polymers, sulfur groups, organic compounds, surfactants, graphene quantum dots, carbon quantum dots, inorganic quantum dots, nanoparticles, and combinations thereof.

In some embodiments, the precursor materials of the present disclosure can include one or more materials. For instance, in some embodiments, the precursor materials of the present disclosure can include a carbon source, such as sucrose. In some embodiments, the precursor materials of the present disclosure can include a carbon source (e.g., sucrose) and a carbon nanotube (e.g., multi-walled carbon nanotubes). In some embodiments, the precursor material of the present disclosure can include a carbon source (e.g., sucrose) and a boron nitride nanotube (e.g., a multi-walled boron nitride nanotube).

In some embodiments, the precursor materials of the present disclosure can include a surfactant. In some embodiments, the precursor materials of the present disclosure can include a surfactant and a carbon source. In some embodiments, the surfactant can be wrapped around the carbon source (e.g., carbon nanotubes, graphene nanoribbons, graphene quantum dots, and the like). Additional combinations of precursor materials can also be envisioned.

Combining Catalytic Materials with Precursor Materials

The combination of catalytic materials with precursor materials can place the materials in contact with one another. This in turn can facilitate the formation of three-dimensional materials from the precursor materials.

Various methods may be utilized to combine catalytic materials with precursor materials. For instance, in some embodiments, the combination step occurs by at least one of mixing, stirring, grinding, pressing, cold-pressing, die casting, molding, heating, spin coating, sonication, dispersion, drop-casting, spray coating, dip coating, physical application, vapor-coating, sublimation, blading, inkjet printing, screen printing, direct placement, dissolution, filtration, thermal evaporation, hydrothermal treatment, and combinations thereof.

In some embodiments, catalytic and precursor materials are combined by grinding the materials in the presence of one another. For instance, in some embodiments, the grinding can occur by using a mortar and pestle.

In some embodiments, catalytic and precursor materials are combined under pressure (i.e., weight pressure). For instance, in some embodiments, the weight pressure may range from about 1 g to about 1500 MPa across a 1 cm diameter structure. In some embodiments, the weight pressure may range from about 0.1 MPa to about 150 MPa across a 1 cm diameter structure. Additional weight pressure ranges can also be envisioned.

In some embodiments, catalytic and precursor materials are combined by pressing the materials in the presence of one another. In some embodiments, the pressing occurs under pressure. In some embodiments, the pressing can occur through the use of a cold press under pressure (e.g., pressures of about 1120 MPa).

In some embodiments, the catalytic and precursor materials are combined in the presence of a solvent. In some embodiments, the solvent includes, without limitation, water, organic solvents, inorganic solvents, and combinations thereof. In some embodiments, the solvent includes water, such as deionized water.

In some embodiments, catalytic and precursor materials are combined by heating the materials in the presence of one another. In some embodiments, the heating occurs at temperatures that range from about 80° C. to about 120° C. In some embodiments, the heating evaporates any solvents.

The catalytic and precursor materials may be combined at various weight ratios. For instance, in some embodiments, the precursor material to catalytic material weight ratio is about 1:1. In some embodiments, the precursor material to catalytic material weight ratio is about 1:6. In some embodiments, the precursor material to catalytic material weight ratio is about 1:10.

In more specific embodiments, catalytic and precursor materials are combined by multiple and sequential steps. For instance, in some embodiments, the catalytic and precursor materials may first be mixed with one another. The mixing may occur under various conditions, such as in the presence of a solvent (e.g., deionized water). The mixing may also occur through various processes. Such processes can include, without limitation, mechanical stirring, grinding, heating, spin coating, sonication, dispersion, drop-casting, spray coating, dip coating, physical application, vapor-coating, sublimation, blading, inkjet printing, screen printing, direct placement, dissolution, filtration, thermal evaporation, hydrothermal treatment, and combinations thereof. In some embodiments, the catalytic and precursor materials may be mixed with one another by dissolution in a solvent followed by filtration or evaporation.

After the mixing step, the catalytic and precursor materials may then be pressed under pressure. Pressing can also occur by various processes that were described previously. For instance, in some embodiments, the pressing can occur by processes that include, without limitation, grinding, pressing, cold-pressing, die casting, molding, drop-casting, and combinations thereof. Additional combination steps can also be envisioned.

Formation of Three-Dimensional Materials

Formation of three-dimensional materials from precursor materials are generally mediated by the catalytic materials after the catalytic materials are combined with the precursor materials. In some embodiments, the formation of three-dimensional materials from precursor materials include connecting precursor materials to one another. In some embodiments, the formation of three-dimensional materials from precursors materials include growing the three-dimensional materials from the precursor materials. In some embodiments, the formation of three-dimensional materials from the precursor materials include connecting precursor materials to one another and growing the three-dimensional materials from the precursor materials.

Various processes may be utilized to form three-dimensional materials from precursor materials in the presence of catalytic materials. For instance, in some embodiments, the processes include, without limitation, chemical vapor deposition, heating, annealing, and combinations thereof.

In some embodiments, three-dimensional materials are formed by heating the precursor materials in the presence of catalytic materials. In some embodiments, the heating occurs at temperatures of more than about 500° C. In some embodiments, the heating occurs at temperatures that range from about 800° C. to about 1,000° C. In some embodiments, the heating occurs at temperatures above 1,000° C.

The formation of three-dimensional materials can occur under various conditions. For instance, in some embodiments, the formation of three-dimensional materials occurs in an inert environment. In some embodiments, the inert environment includes a stream of an inert gas or reducing gas. In some embodiments, the inert gas includes, without limitation, H₂, Ar, He, and combinations thereof. In some embodiments, the inert gas includes H₂ and Ar. In some embodiments, a stream of H₂ is utilized as a reducing gas at high temperatures (e.g., temperatures of about 500° C. to about 1,000° C.).

In some embodiments, the formation of three-dimensional materials occurs under a vacuum. In some embodiments, the formation of three-dimensional materials occurs in a pressurized environment. For instance, in some embodiments, the formation of three-dimensional materials occurs in a pressurized chamber, such as a quartz tube furnace. In some embodiments, the formation of three-dimensional materials occurs at pressures below atmospheric pressures, such as pressures at or about 9 Torr. In some embodiments, the formation of three-dimensional materials occurs at atmospheric pressure (i.e., pressures above 760 Torr). In some embodiments, the formation of three-dimensional materials occurs at pressures higher than atmospheric pressure (e.g., pressures from about 1.1 atm to about 10 atm).

Separation of Three-Dimensional Materials from Catalytic Materials

In some embodiments, the methods of the present disclosure also include a step of separating the formed three-dimensional materials from the catalytic materials. Various methods may be utilized to separate the formed three-dimensional materials from the catalytic materials. For instance, in some embodiments, the separation of catalytic materials from the formed three-dimensional materials can occur by at least one of etching, dissolution, extraction, physical separation, catalytic material oxidation, washing, and combinations thereof.

In some embodiments, the separation of catalytic materials from the formed three-dimensional materials can occur by etching. In some embodiments, the etching occurs in an aqueous solution, such as an FeCl₃ aqueous solution.

In some embodiments, the separation of catalytic materials from the formed three-dimensional materials can occur by washing. In some embodiments, the washing can occur in various solvents, such as aqueous solvents, organic solvents, and combinations thereof. In some embodiments, the washing can occur in an aqueous solution, such as deionized water, acidic water, alkaline water, and combinations thereof. In some embodiments, the washing can occur in an aqueous solution that contains an organic solvent (e.g., glycols, alcohols, and combinations thereof).

In some embodiments, the separation of catalytic materials from the formed three-dimensional materials can occur by washing and etching. Additional separation methods can also be envisioned. For instance, in some embodiments, the separation of catalytic materials from the formed three-dimensional materials can occur by oxidation of the catalytic material (e.g., a catalytic metal) followed by dissolution of the oxidized catalytic material. In some embodiments, the dissolution can take place in various aqueous solutions that were described previously (e.g., water, acid water, alkaline water, and combinations thereof).

Three-Dimensional Materials

The methods of the present disclosure can be utilized to form various types of three-dimensional materials. Additional embodiments of the present disclosure pertain to the three-dimensional materials.

In some embodiments, the three-dimensional materials of the present disclosure include a three-dimensional structure (e.g., three-dimensional structure 32 shown in FIG. 1B) and a plurality of connected units (e.g., connected units 34, 36 and 38 shown in FIG. 1B). In some embodiments, the plurality of connected units are on surfaces and internal cavities of the three-dimensional material.

Connected Units

The three-dimensional materials of the present disclosure can include various types of connected units. In some embodiments, the connected units are connected components of the precursor materials. In some embodiments, the connected units are grown from the precursor materials. In some embodiments, the connected units are connected and grown components of the precursor materials. In some embodiments, the connected units include, without limitation, graphene, carbon shells, phosphorenes, boron nitrides, metal layers, carbon nanotubes, polymers, graphene nanoribbons, boron nitride nanotubes, chalcogenide nanotubes, metal chalcogenide nanotubes, nanoparticles, nanorods, nanowires, carbon onions, hybrid materials thereof, composites thereof, and combinations thereof.

In some embodiments, the connected units of the three-dimensional materials include graphene. In some embodiments, the graphene is grown from a precursor material, such as a carbon source (e.g., sucrose). In some embodiments, the graphene includes, without limitation, monolayer graphene, bilayer graphene, multilayer graphene, polycrystalline graphene, pristine graphene, single-crystal graphene, graphite, doped graphene, graphene oxide, functionalized graphene, and combinations thereof. In some embodiments, the graphene includes doped graphene, such as N-doped graphene. In some embodiments, the graphene includes multilayer graphene, such as bilayer graphene.

In some embodiments, the connected units of the three-dimensional materials include metal layers. In some embodiments, the metal layers are grown from precursor materials, such as metal hydrides (e.g., ammonia borane). In some embodiments, the metal layers include MXₙ. In some embodiments, M includes, without limitation, Mo, W, Bi, Hf, Ga, Ge, Ta, Sn, Zn, Cd, Pb, B, Nb, Zr, Ti, W, Nb, Si, and combinations thereof. In some embodiments, X includes, without limitation, O, C, S, N, Se, Te, and combinations thereof. In some embodiments, n is 1, 2 or 3.

In some embodiments, the connected units of the three-dimensional materials include hybrid materials. In some embodiments, the hybrid materials include hybrids of precursor materials and connected units grown from the precursor materials. In some embodiments, the connected units of the three-dimensional materials include graphene hybrid materials. In some embodiments, the graphene hybrid materials include, without limitation, graphene-carbon nanotube hybrid materials, graphene-carbon onion hybrid materials, graphene-carbon shell hybrid materials, graphene-boron nitride hybrid materials, graphene-carbon nanotube-carbon shell hybrid materials, graphene-boron nitride nanotube-carbon shell hybrid materials, and combinations thereof.

In some embodiments, the connected units of the three-dimensional materials include graphene-carbon nanotube hybrid materials. In some embodiments, the graphene-carbon nanotube hybrid materials include graphene-multi-walled carbon nanotube hybrid materials.

In some embodiments, the connected units of the three-dimensional materials include graphene-carbon nanotube-carbon shell hybrid materials. In some embodiments, the carbon nanotubes constitute from about 1 wt % to about 50 wt % of the total carbon mass of the hybrid materials. In some embodiments, the carbon nanotubes constitute about 20 wt % of the total carbon mass of the hybrid materials.

In some embodiments, the connected units of the three-dimensional materials include graphene-boron nitride nanotube hybrid materials. In some embodiments, the graphene-boron nitride nanotube hybrid materials include graphene-multi-walled boron nitride nanotube hybrid materials. In some embodiments, the connected units of the three-dimensional materials include graphene-boron nitride nanotube-carbon shell hybrid materials.

The connected units of the three-dimensional materials of the present disclosure may be associated with one another through various bonds. For instance, in some embodiments, the connected units may be associated with one another through at least one of ionic bonds, covalent bonds, non-covalent bonds, van der Waals forces, electrostatic interactions, London dispersion forces, π-π stacking interactions, and combinations thereof.

In some embodiments, the connected units of the present disclosure may be associated with one another through covalent bonds. In some embodiments, the connected units of the present disclosure may be associated with one another through π-π stacking interactions, such as through π-π stacked bridges.

In some embodiments, the connected units of the present disclosure may be merged seamlessly with one another. In some embodiments, the connected units of the present disclosure reinforce one another and the three-dimensional structure.

The connected units of the present disclosure can include various shapes. For instance, in some embodiments, the shapes of the connected units can include, without limitation, square-like shapes, circular shapes, doughnut-like shapes, disk-like shapes, cross-hatches, hollow shapes, sheet-like structures, and combinations of such shapes. In some embodiments, the connected units of the present disclosure can include intricate shapes of any desired format that can be formed from the precursors.

The connected units of the present disclosure can also include various thicknesses. For instance, in some embodiments, the connected units of the present disclosure are 1 atom thick. In some embodiments, the connected units of the present disclosure are more than 1 atom thick (e.g., 2-5 atoms thick). In some embodiments, the connected units of the present disclosure have thicknesses ranging from about 1 μm to about 100 μm. In some embodiments, the connected units of the present disclosure have a thickness of about 20 μm.

The connected units of the three-dimensional materials of the present disclosure may also have various arrangements. For instance, in some embodiments, the connected units of the present disclosure are in-plane with one another. In some embodiments, the connected units of the present disclosure are randomly oriented with one another. In some embodiments, the connected units of the present disclosure are interconnected with one another. In some embodiments, the connected units of the present disclosure form a continuous network. In some embodiments, the connected units of the present disclosure are intertwined with one another. In some embodiments, the connected units of the present disclosure are intertwined with one another in regular cross-hatched or patterned arrays.

Three-Dimensional Shapes

The three-dimensional materials of the present disclosure can have various shapes. For instance, in some embodiments, the three-dimensional materials of the present disclosure can include a foam-like structure. In some embodiments, the three-dimensional materials of the present disclosure can include a crystalline structure.

In some embodiments, the three-dimensional materials of the present disclosure can be in the shape of particles. In some embodiments, the particles may be interconnected with one another (e.g., interconnected particles 31 shown in FIG. 1B).

In some embodiments, the particles may include, without limitation, micro-particles, nano-particles, and combinations thereof. In some embodiments, the particles have sizes that range from about 100 nm to about 1 millimeter in diameter. In some embodiments, the particles have sizes that range from about 100 nm to about 100 μm in diameter. In some embodiments, the particles have sizes that range from about 1 μm to about 5 μm in diameter. In some embodiments, the particles have sizes that range from about 2 μm to about 3 μm in diameter. In some embodiments, the particles have sizes of about 1 μm in diameter.

The three-dimensional materials of the present disclosure can also have various shapes. For instance, in some embodiments, the three-dimensional materials of the present disclosure are in the form of particles (e.g., nanoparticles) that have spherical, rod-like, ellipsoidal, tetrahedral, pronged, or other shapes.

The three-dimensional materials of the present disclosure can also have various surface areas. For instance, in some embodiments, the three-dimensional materials of the present disclosure have surface areas of more than about 50 m²/g. In some embodiments, the three-dimensional materials of the present disclosure have surface areas ranging from about 50 m²/g to about 2,500 m²/g. In some embodiments, the three-dimensional materials of the present disclosure have surface areas ranging from about 500 m²/g to about 1,500 m²/g.

In some embodiments, the three-dimensional materials of the present disclosure have surface areas of about 80 m²/g. In some embodiments, the three-dimensional materials of the present disclosure have surface areas of more than about 500 m²/g. In some embodiments, the three-dimensional materials of the present disclosure have surface areas of more than about 750 m²/g. In some embodiments, the three-dimensional materials of the present disclosure have surface areas of more than about 1,000 m²/g. In some embodiments, the three-dimensional materials of the present disclosure have surface areas of about 1,080 m²/g.

In some embodiments, the three-dimensional materials of the present disclosure have surface areas ranging from about 50 m²/g to about 2,500 m²/g. In some embodiments, the three-dimensional materials of the present disclosure have surface areas ranging from about 500 m²/g to about 1,500 m²/g.

The three-dimensional materials of the present disclosure can also have various porosities. For instance, in some embodiments, the three-dimensional materials of the present disclosure have at least one of mesopores, micropores, nanopores, and combinations thereof. In some embodiments, the three-dimensional materials of the present disclosure have pore diameters between about 1 nm to about 500 nm. In some embodiments, the three-dimensional materials of the present disclosure have pore diameters between about 1 nm to about 100 nm. In some embodiments, the three-dimensional materials of the present disclosure have pore diameters between about 1 nm to about 50 nm. In some embodiments, the three-dimensional materials of the present disclosure have pore diameters between about 1 nm to about 10 nm. In some embodiments, the three-dimensional materials of the present disclosure have pore diameters between about 3 nm to about 7.5 nm.

In some embodiments, the three-dimensional materials of the present disclosure have porosities of more than about 80%. In some embodiments, the three-dimensional materials of the present disclosure have porosities of more than about 90%. In some embodiments, the three-dimensional materials of the present disclosure have porosities of more than about 95%.

The three-dimensional materials of the present disclosure can also have various densities. For instance, in some embodiments, the three-dimensional materials of the present disclosure have densities of ranging from about 0.1 g/cm³ to about 1 g/cm³. In some embodiments, the three-dimensional materials of the present disclosure have densities of ranging from about 0.1 g/cm³ to about 0.5 g/cm³. In some embodiments, the three-dimensional materials of the present disclosure have densities of ranging from about 0.1 g/cm³ to about 0.25 g/cm³.

The three-dimensional materials of the present disclosure can also have various thicknesses. For instance, in some embodiments, the three-dimensional materials of the present disclosure have thicknesses of more than about 10 μm. In some embodiments, the three-dimensional materials of the present disclosure have a thickness of about 20 μm. In some embodiments, the three-dimensional materials of the present disclosure have thicknesses ranging from about 20 μm to about 1 mm. In some embodiments from 1 mm to 1 meters in thickness. The thickness of the final structure only depends on the size of the mold for the cold pressing. In some embodiments, the three-dimensional materials of the present disclosure are free-standing.

Shape and Porosity Control

In various embodiments, the shapes of the three-dimensional materials of the present disclosure can represent the shape of the catalytic material. As such, in some embodiments, the methods of the present disclosure can also include steps of controlling the shape of the three-dimensional materials. For instance, in some embodiments, the shape of the three-dimensional materials is controlled by adjusting the shape of the catalytic material. In some embodiments, the shape of the catalytic materials may be adjusted by pressing the catalytic materials into a desired shape (e.g., pellets, screws, sheets, filter shapes, and any other desired shapes) before the formation of three-dimensional materials.

In some embodiments, the shape of the three-dimensional material is controlled by selecting the shape of the catalytic material. For instance, in some embodiments, a desired shape of a catalytic material is selected and used to form three-dimensional materials that represent the shape of the catalytic material.

In additional embodiments, the methods of the present disclosure can also include methods of controlling the porosity of the three-dimensional materials. For instance, in some embodiments, the porosity of the three-dimensional materials is controlled by adjusting the porosity of the catalytic material. In some embodiments, the porosity of the three-dimensional material is controlled by selecting the porosity of the catalytic material. For instance, in some embodiments, a desired porosity of a catalytic material is selected and used to form three-dimensional materials that represent the porosity of the catalytic material.

In some embodiments, the porosity of the three-dimensional material is controlled by adjusting the weight pressure during the step of combining catalytic materials with precursor materials. For instance, in some embodiments, an increase of the weight pressure during the combining step reduces the porosity of the three-dimensional material. In some embodiments, a decrease of the weight pressure during the combining step increases the porosity of the catalytic material.

Additional parameters may also be adjusted to control the shape and type of three-dimensional materials. For instance, in some embodiments, the types of catalytic materials and precursor materials may be selected in order to obtain a desired type of three-dimensional material.

Three-Dimensional Material Properties

The three-dimensional materials of the present disclosure can have various advantageous properties. For instance, in some embodiments, the three-dimensional materials of the present disclosure have a storage modulus of about 10 kPa to about 350 kPa. In some embodiments, the three-dimensional materials of the present disclosure have a storage modulus of about 200 kPa to about 350 kPa. In some embodiments, the three-dimensional materials of the present disclosure have a storage modulus of about 290 kPa.

The three-dimensional materials of the present disclosure can also have various conductivities. For instance, in some embodiments, the three-dimensional materials of the present disclosure have conductivities ranging from about 10 S/cm to about 50 S/cm. In some embodiments, the three-dimensional materials of the present disclosure have conductivities of about 20 S/cm.

The three-dimensional materials of the present disclosure can also have various advantageous mechanical properties. For instance, in some embodiments, the three-dimensional materials of the present disclosure support at least about 1,000 times their weight without any irreversible height change. In some embodiments, the three-dimensional materials of the present disclosure support at least about 2,000 times their weight without any irreversible height change. In some embodiments, the three-dimensional materials of the present disclosure support at least about 3,000 times their weight without any irreversible height change. In some embodiments, the three-dimensional materials of the present disclosure support at least about 5,000 times their weight without any irreversible height change.

Applications

The three-dimensional materials of the present disclosure can have various applications. For instance, in some embodiments, the three-dimensional materials of the present disclosure can be utilized as components of an energy storage device. In some embodiments, the three-dimensional materials of the present disclosure can be utilized as electrode materials in an energy storage device. In some embodiments, the three-dimensional materials of the present disclosure can be utilized as binder-free electrodes in an energy storage device. In some embodiments, the three-dimensional materials of the present disclosure can be utilized as cathodes or anodes in an energy storage device.

In additional embodiments, the methods of the present disclosure also include a step of incorporating the three-dimensional materials of the present disclosure as a component of an energy storage device. Additional embodiments of the present disclosure pertain to energy storage devices that contain the three-dimensional materials of the present disclosure.

The three-dimensional materials of the present disclosure can be incorporated into various types of energy storage devices. For instance, in some embodiments, the energy storage device includes, without limitation, capacitors, batteries, photovoltaic devices, photovoltaic cells, transistors, current collectors, fuel cell devices, water-splitting devices, and combinations thereof. In some embodiments, the energy storage device is a battery. In some embodiments, the battery includes, without limitation, rechargeable batteries, non-rechargeable batteries, micro batteries, lithium-ion batteries, lithium-sulfur batteries, lithium-air batteries, sodium-ion batteries, sodium-sulfur batteries, sodium-air batteries, magnesium-ion batteries, magnesium-sulfur batteries, magnesium-air batteries, aluminum-ion batteries, aluminum-sulfur batteries, aluminum-air batteries, calcium-ion batteries, calcium-sulfur batteries, calcium-air batteries, zinc-ion batteries, zinc-sulfur batteries, zinc-air batteries, and combinations thereof.

In some embodiments, the energy storage device is a capacitor. In some embodiments, the capacitor includes, without limitation, lithium-ion capacitors, lithium-sulfur capacitors, and combinations thereof. In some embodiments, the capacitor includes lithium-ion capacitors.

### Additional Embodiments

Reference will now be made to more specific embodiments of the present disclosure and experimental results that provide support for such embodiments. However, Applicants note that the disclosure herein is for illustrative purposes only and is not intended to limit the scope of the claimed subject matter in any way.

### EXAMPLE 1

### Preparation of Three-dimensional Graphene Foams Using Powder Metallurgy Templates

In this Example, a facile and scalable method which combines traditional powder metallurgy and chemical vapor deposition is described for the synthesis of mesoporous free-standing three-dimensional (3D) graphene foams. The powder metallurgy templates for 3D graphene foams (PMT-GFs) consist of particle-like carbon shells which are connected by multi-layered graphene that shows high specific surface area (1080 m² g⁻¹), good crystallization, good electrical conductivity (13.8 S cm⁻¹), and a mechanically robust structure. The PMT-GFs did not break under direct flushing with de-ionized (DI) water and they were able to recover after being compressed.

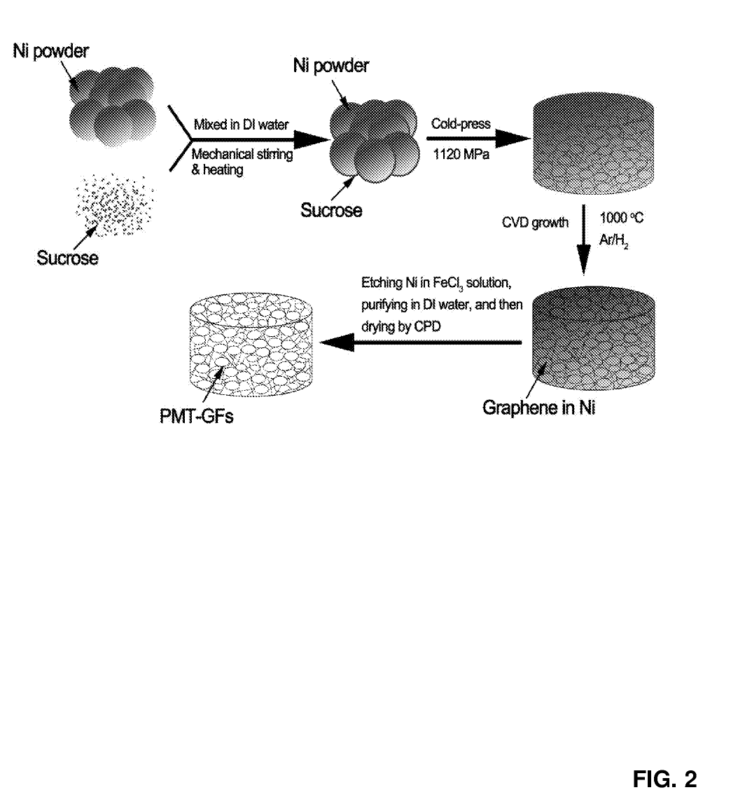

As shown in in the scheme in FIG. 2, PMT-GFs were prepared by mixing Ni powders and sucrose in DI water. After evaporating the water, the PMT-GFs were dried overnight, ground into a powder, and pressed into pellets. After growth, etching, purifying, and drying, free-standing PMT-GFs were obtained. In this method, the sintered Ni skeleton and sucrose act as a template and solid carbon source, respectively. Graphene grows on the surface of the pellets and the interface regions of the Ni particles which can also absorb extra amorphous carbon, and thereby form a network inside the Ni pellets, suggesting a porous structure and high degree of crystallization.

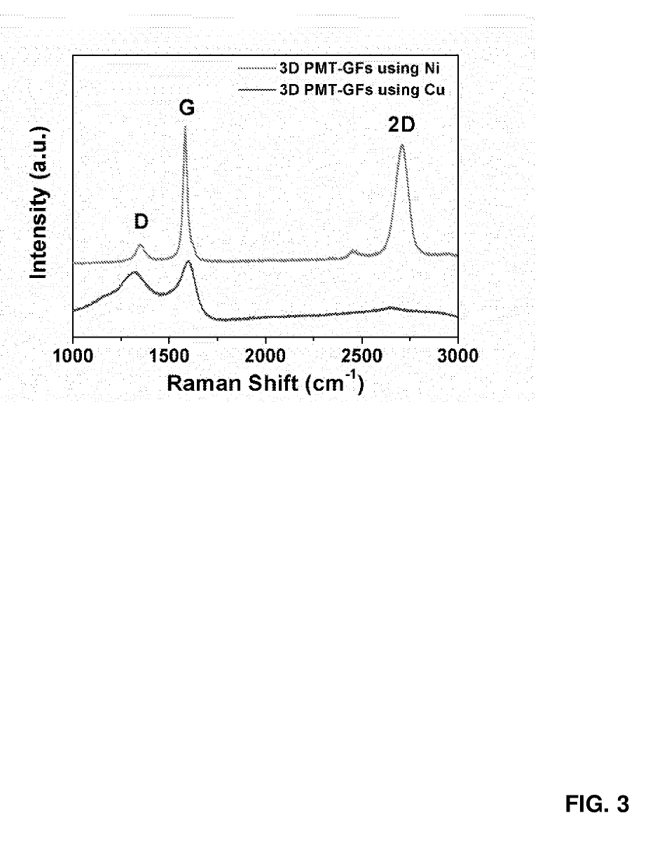

The solubility of carbon in Cu is much lower than in Ni. Therefore, when using Cu particles as a template, the monolith had little structural integrity and Raman spectroscopy, and the product showed little graphene material formation (FIG. 3). As shown in FIG. 3, the I_{D}/I_{G} ratio of the PMT-GFs when using Cu is higher than the PMT-GFs when using Ni. Without being bound by theory, it is envisioned that the aforementioned observations is because Ni absorbs more amorphous carbon. Moreover, the 3D PMT-GFs that used Cu had low structural stability (i.e. easily broken) because the graphene formed on the Cu particles were just a few layers. The procedure used in preparing the PMT-GFs of FIG. 3 used poly(methyl methacrylate) as a carbon source and chloroform as the solvent.

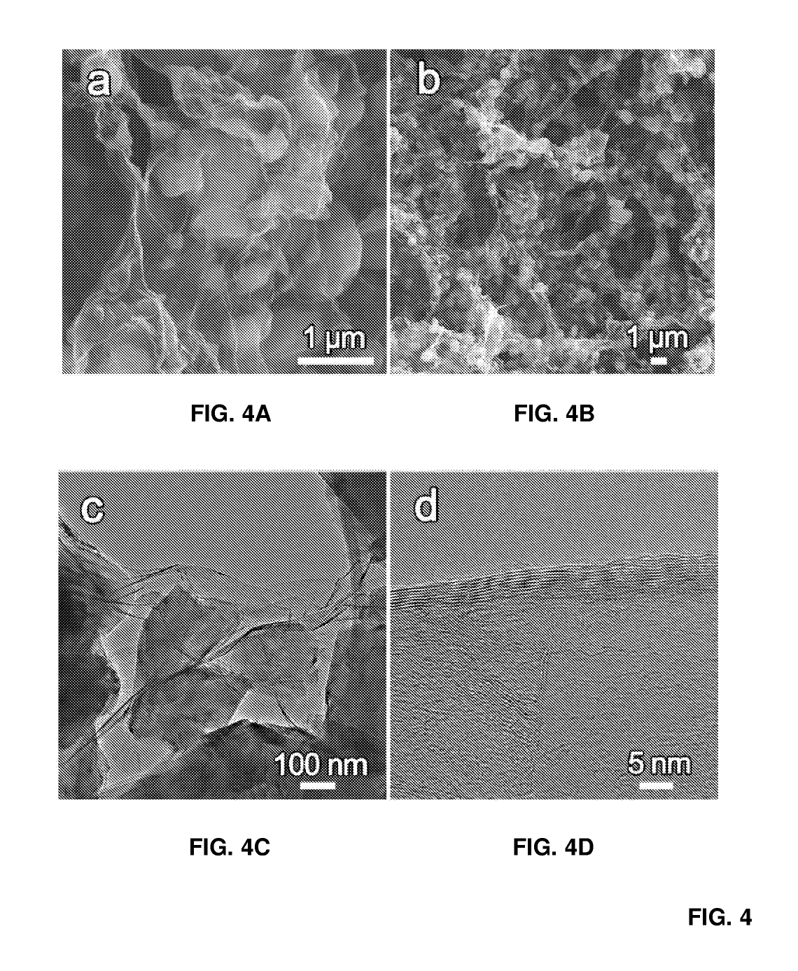

FIG. 4A shows that the Ni-derived PMT-GF consists of particle-like carbon shells connected by 2D graphene layers. After the complete synthetic sequence where the Ni is removed, the size of the particle-like carbon shells is about 1 μm, which is comparable to the size of the starting single Ni particles. The size of the holes shown in FIG. 4B is also comparable to the size of the starting Ni particles. This suggests that the pore size of PMT-GFs is controllable by adjusting the size of Ni particles.

FIGS. 4C-D show that the graphene layers are multi-layered with high crystallization and that the carbon shells are connected by a 2D graphene layer network indicating that the PMT-GFs are structurally stable. Physical integrity was tested by flushing the PMT-GFs with deionized water (DI) and loading with different weights. Applicants observed that the PMT-GFs did not break under a stream of DI water and even withstood directly being hit by the stream.

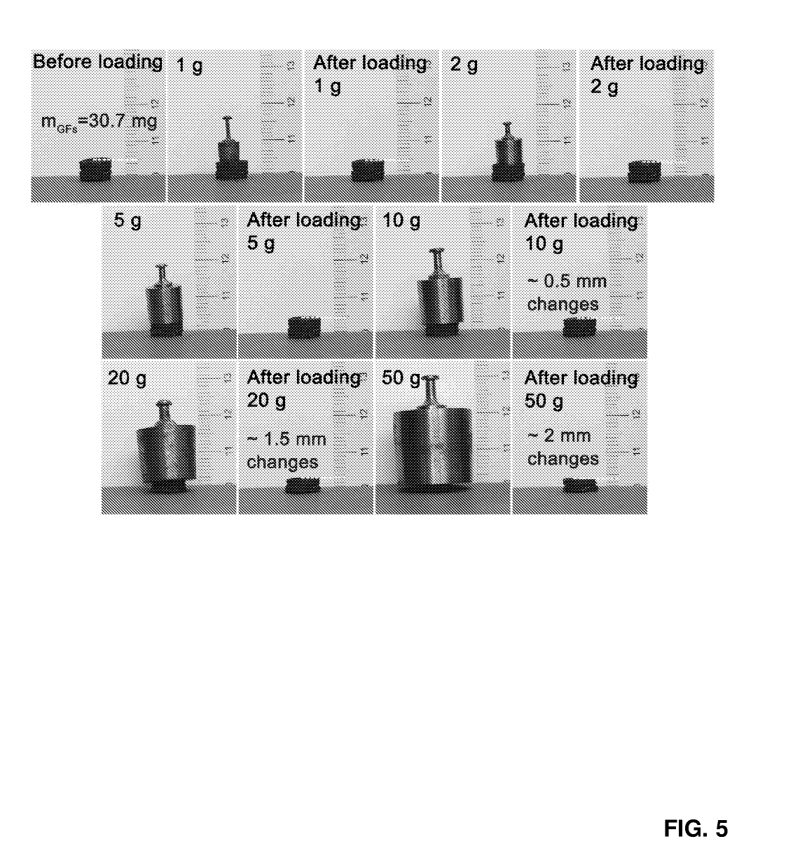

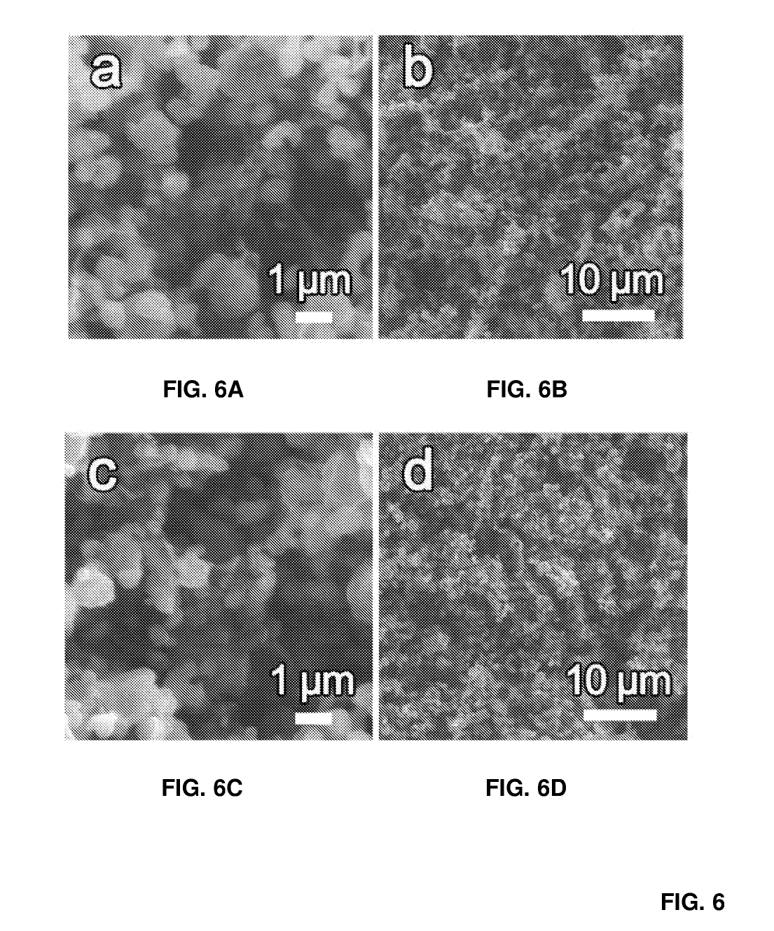

As shown in FIG. 5, after loading weights which are more than 150 times the foam's weight (˜30 mg), there was a rapid return of the full pellet height. However, after loading with a 20 g weight, the foam showed a change in height of about 30% when the load was removed. Even after applying a 50 g load and then removing the load, the foam only decreased in height by about 40%. Scanning electron microscopy (SEM) images (FIG. 6) of the PMT-GFs show no apparent morphological changes before and after loading with a 50 g weight, thus underscoring the foam's structural resiliency.

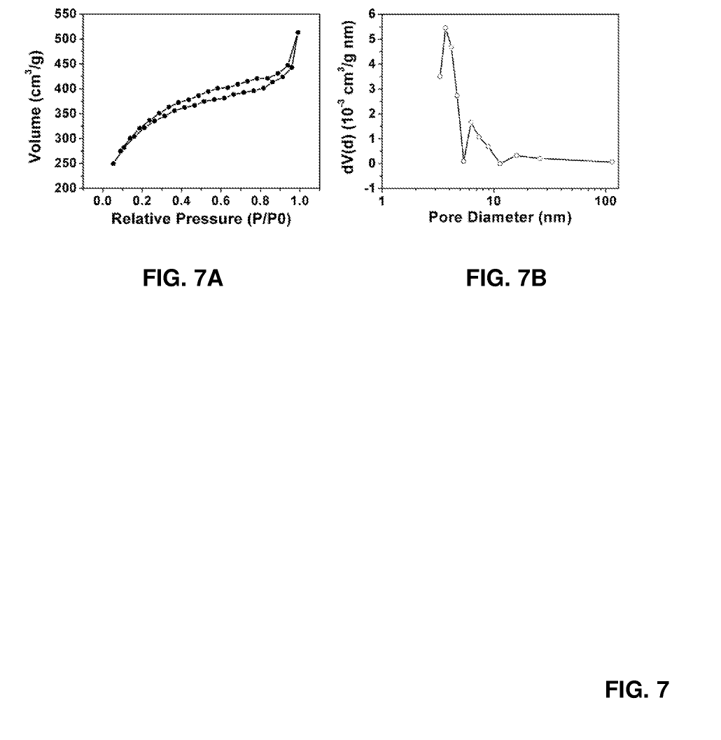

To investigate the pore structure and specific surface area of PMT-GFs, nitrogen adsorption-desorption isotherms were measured, as shown in FIG. 7. The specific surface area was calculated using the BET method and the pore size distribution data was determined by the BJH method. The curve in FIG. 7A shows a hysteresis loop, which means that the PMT-GFs contains both mesopores and macropores. The BET specific surface area of PMT-GFs is ˜1080 m²/g. FIG. 7B shows that the pore diameters are ˜3.7 and ˜6.3 nm, which indicates that the as-prepared PMT-GFs are mesoporous.

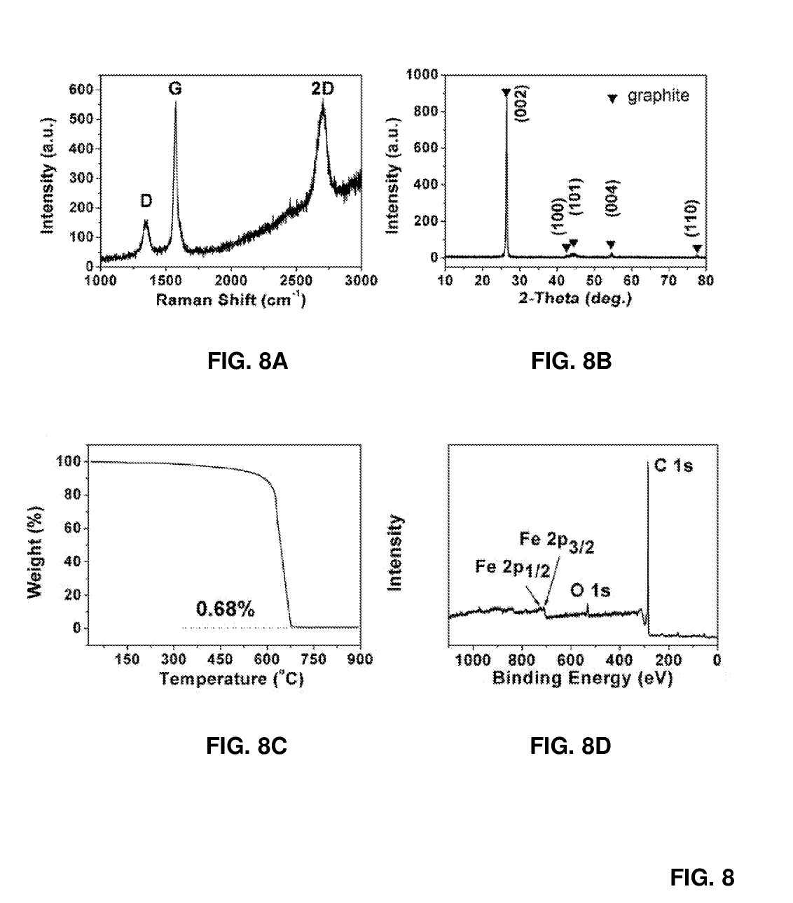

To further investigate the quality, phase, and components of the PMT-GFs, Raman analysis, XRD, TGA, and XPS were performed, as shown in FIG. 8. From the Raman spectra in FIG. 8A, the peak at 1352 cm⁻¹ (D band) represents disordered sp³ C, which shows the amount of defects in materials. The peak at 1580 cm⁻¹ (G band) represents sp² C in graphene and the ratio of G/2D band can indicate if the graphene is monolayer or few-layer. The I_{D}/I_{G} ratio of PMT-GFs is 0.27, which indicates the graphene foam with few defects. The I_{G}/I_{2D} ratio of PMT-GFs is 1.56, which shows that the graphene in PMT-GFs is multi-layered graphene. This result is in accord with the transmission electron microscopy (TEM) image shown in FIG. 4D.

As shown in FIG. 8B, the diffraction peaks of 26.3°, 42.2°, 44.4°, 54.5°, and 77.3° represent the crystal planes of (002), (100), (101), (004), and (110) of graphene, respectively (JCPDS 75-1621). The diffraction peaks match well with the graphite phase. In addition, no apparent peaks of Ni, Fe, NiO, FeCl₃, and FeₓO_{y} from the template or etch solution can be observed. This indicates that the amount of impurities is very low.

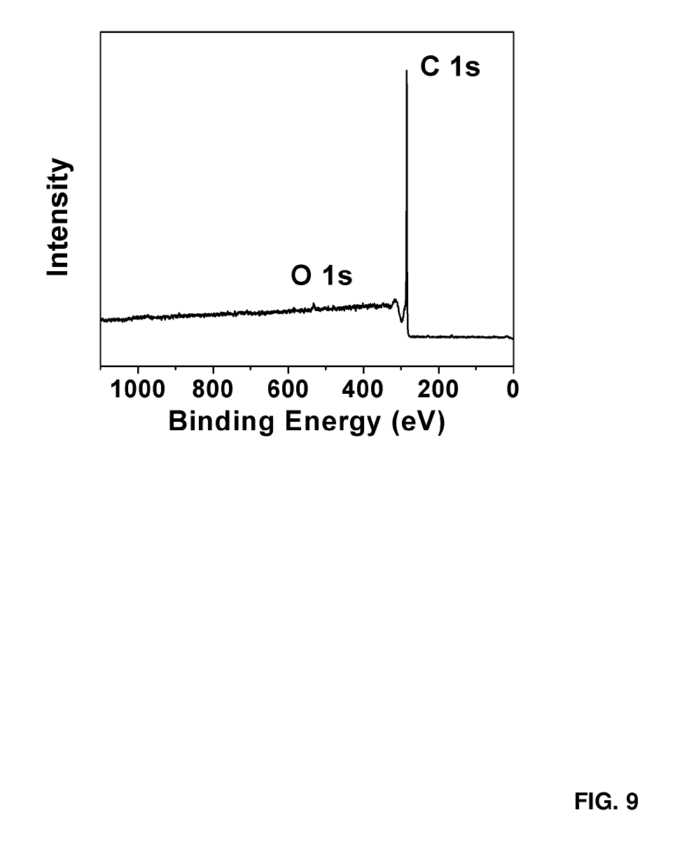

As shown in FIG. 8C, only 0.68 wt % of mass remained after the thermogravimetric analysis (TGA) of the PMT-GFs from room temperature to 900° C. in air, indicating that the metal can be nearly completely removed after FeCl₃ etching. However, from the XPS results shown in FIG. 8D, there remains Fe impurities on the graphene, which was used to etch the Ni. To further purify the PMT-GFs, the PMT-GFs were annealed at 800° C. in Ar (500 sccm) for 2 hours. After heat-treatment, no apparent Fe peaks could be observed using XPS (FIG. 9). Furthermore, the elemental contents of PMT-GFs before and after the purifying heat-treatment are shown in Table 1.

TABLE 1
The elemental content as determined by XPS in PMT-
GFs before and after the purifying heat-treatment.

| | C 1s (%) | O 1s (%) | Fe 2p³ (%) | Ni 2p³ (%) |
|---|---|---|---|---|
| Before | 94.83 | 4.02 | 1.15 | 0.00 |
| After | 97.54 | 2.35 | 0.11 | 0.00 |

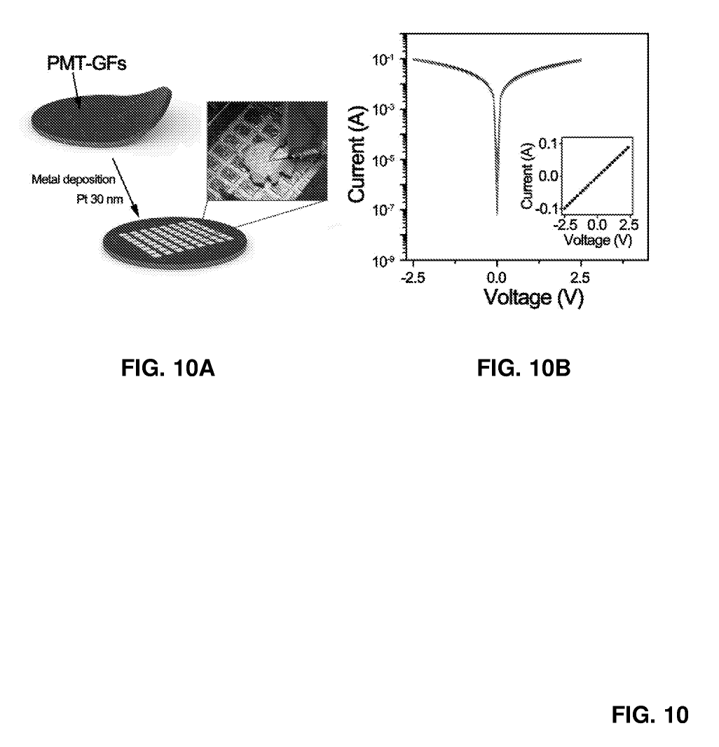

The aforementioned results indicate that the PMT-GFs have high specific surface area and good resilience. Next, the conductivity of PMT-GFs was directly tested. As shown in FIG. 10A, platinum contact pads with a size of 250 μm×250 μm were deposited using a shadow mask evaporation method. The distance between the contacts was 120 μm.

FIG. 10B shows the room-temperature electrical conductivity of a 20 μm thick PMT-GF. As shown in the inset of FIG. 10B, the linear dependence between current and applied voltage indicates Ohmic contact of the platinum with the graphene foam. The electrical transport characteristics provide a value of the electrical conductivity of 3D PMT-GFs: σ=I·l/V·A=13.84 S cm⁻¹, where I, l, V and A is the measured current, length of channel (the distance between two pads), applied voltage and cross-sectional area of 3D PMT-GFs, respectively. As expected, the PMT-GFs show good electrical conductivity.

In sum, this Example demonstrates the synthesis of mesoporous free-standing 3D graphene foams with high specific surface area, high quality, good resilience, and high electrical conductivity. The graphene foams were synthesized by a powder metallurgy and CVD approach.

### EXAMPLE 1.1

### Preparation of PMT-GFs

All chemicals were analytical grade and used without further purification. PMT-GFs were synthesized by powder metallurgy templates with Ni powders as templates and sucrose as the carbon source. In brief, 3 g of Ni powders (particle size: 2.2-3.0 μm) and 0.5 g of sucrose were mixed in 150 mL deionized (DI) water. This mixture was heated at 120° C. to evaporate water under mechanical stirring. The hybrid powders were dried at 80° C. in vacuum overnight and ground using a mortar and pestle. Next, the powders were pressed into pellets for 5 minutes at a pressure of ˜1120 MPa using a die. The pellets were then loaded into a quartz tube furnace to grow graphene with an atmosphere of H₂/Ar (200 sccm/500 sccm) at a chamber pressure of about 9 Torr. The temperature was increased to 1,000° C. at a heating rate of 10° C. min⁻¹ and the pellets were further annealed at 1000° C. for 30 minutes. After heating, the pellets were quickly removed from the hot region of the furnace using a magnetic extraction boat, and they were then allowed to cool to room temperature. Finally, the Ni pellets were etched in 1 M FeCl₃ aqueous solution (200 mL, refilled with new solution every day until no color change) for 1 week and then transferred into DI water. The foams were purified in DI water for 1 week (200 mL, refilled with new solution every day until no color change), and dried using a critical point dryer (CPD, Supercritical Automegasamdri-915B) to obtain free-standing PMT-GFs.

### EXAMPLE 1.2

### Characterization

The morphology of the PMT-GFs was determined using a scanning electron microscope (SEM, JEOL 6500F) operated at 10 kV and a high-resolution transmission electron microscope (TEM, JEOL JEM-2100F) operated at 200 kV. All Raman spectra were recorded with a Renishaw Raman RE01 scope. The X-ray diffraction (XRD) patterns were performed with a powder X-ray diffraction system (Rigaku D/Max Ultima II, Cu Kα radiation). Thermogravimetric analyses (TGA) were carried out from room temperature to 900° C. in air with a Q-600 Simultaneous TGA/DSC from TA Instruments. Nitrogen adsorption-desorption isotherms were measured at 77 K by a Quantachrome Autosorb-3b Brunauer-Emmett-Teller (BET) Surface Analyzer. The specific surface area was calculated from the BET method and the pore size distribution data was determined by the Barrett-Joyner-Halenda (BJH) method. X-ray photoelectron spectroscopy (XPS) characterization was carried out on a PHI Quantera SXM scanning X-ray microprobe with a 100 μm beam size and a 45° take off angle. Electrical conductivity was analyzed with an Agilent B1500A semiconductor parameter analyzer using a customized DC probe station by a two-probe configuration measurement method under ambient atmosphere and room temperature. Platinum contact pads with a size of 250 μm×250 μm were deposited onto a 20 μm thick PMT-GF using shadow mask evaporation. The distance between the contacts was 120 μm.

### EXAMPLE 2

### Preparation of Three-Dimensional Rebar Graphene

In this Example, Applicants demonstrate the development of free-standing and robust three-dimensional (3D) rebar graphene foams (GFs) by a powder metallurgy template method with multi-walled carbon nanotubes (MWCNTs) as a reinforcing bar, sintered Ni skeletons as a template and catalyst, and sucrose as a solid carbon source. As a reinforcement and bridge between different graphene sheets and carbon shells, MWCNTs improved the thermostability, storage modulus (290.1 kPa) and conductivity (21.82 S cm⁻¹) of 3D GF, resulting in a high porosity and structurally stable 3D rebar GF. The 3D rebar GF can support more than 3,150 times the foam's weight with no irreversible height change. In addition, the 3D rebar GF shows only about a 25% irreversible height change after loading more than 8,500 times the foam's weight. The 3D rebar GF also shows stable performance as a highly porous electrode in lithium ion capacitors (LICs) with an energy density of 32 Wh kg⁻¹. After 500 cycles of testing at a high current density of 6.50 mA cm ², the LIC shows 78% energy density retention.

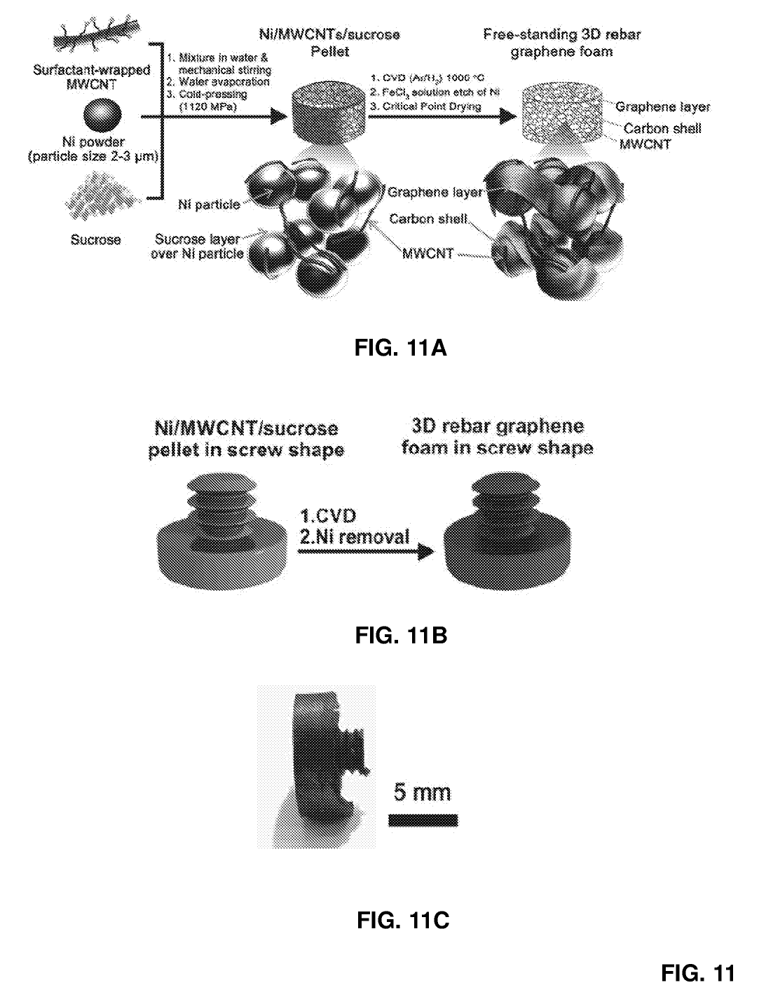

As shown in FIG. 11A, Ni powders, sucrose, and a MWCNT suspension were mixed into deionized (DI) water under mechanical stirring and heating. After evaporating the solvent and drying overnight in vacuum. Ni/sucrose/MWCNT hybrid powders were obtained. In this process, when using a 25 mL MWCNT suspension that contains 25 mg MWCNTs and 25 mg Pluronic F127 surfactant (the mass percentage of C atom in the surfactant is about 30%), the MWCNT content relative to the total carbon atomic mass (sucrose+MWCNTs+surfactant) was about 10%. This sample is referred to as 3D rebar-10 GF. Similarly, samples prepared using a 50 mL MWCNT suspension that contains 50 mg MWCNTs and 50 mg surfactant were referred to as 3D rebar-18 GF, meaning that the MWCNTs content relative to the total carbon mass was about 18%.

The hybrid powders were cold-pressed into pellets in a steel die under a pressure of about 1120 MPa and then loaded into a quartz tube furnace to convert the sucrose and surfactant into graphene at 1,000° C. under an atmosphere of Ar/H₂ for 30 minutes. After etching of the Ni in a FeCl₃ aqueous solution (1 M) and then drying, free-standing 3D rebar GF pellets were obtained. The drying process uses critical point drying (CPD), which is standard clean room equipment. Compared to drying with heat or freeze drying, CPD dries the samples without changes in volume, thereby maintaining the structural integrity of the samples. In this process, the sintered Ni skeleton acts as a template and catalyst, and the sucrose and surfactant act as carbon sources. Graphene grows on the surface of the pellet and in the interface region between the Ni particles. MWCNTs can act as the bridge among different graphene sheets and carbon shells, working as a reinforcing bar in the GF structure.

The method in this Example is facile and scalable. By changing the structure of the die, the shape of the final 3D rebar GF is tunable. As shown in FIG. 11B, if the pellet of Ni/sucrose/MWCNTs is prepared into a screw shape, a free-standing all-carbon 3D rebar GF screw can be fabricated. This shows that the carbon material in 3D rebar GF can retain its original shape after Ni etching and drying. Even the minor threaded details of the screw can be clearly observed from the photograph in FIG. 11C. Moreover, the structural stability of 3D rebar GFs due to the MWCNT rebar addition is much better than that of pure GFs (no rebar).

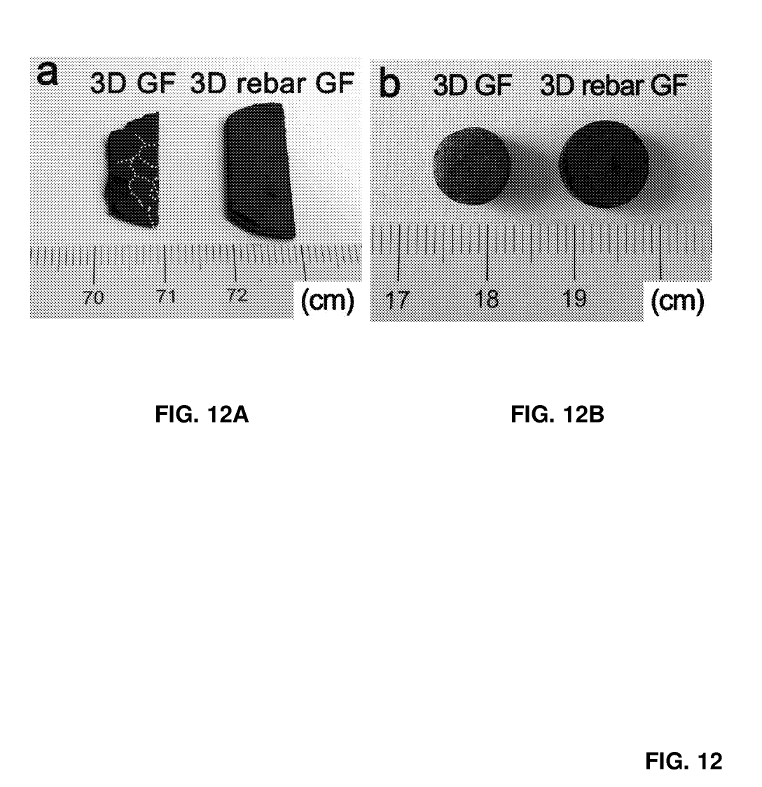

As shown in FIG. 12A, after drying, the 3D GF without rebar shows cracks on the surface that are highlighted in yellow. However, the 3D rebar GF remained crack-free and showed almost no shrinkage.

Furthermore, the 3D GF without rebar showed shrinkage, as shown in FIG. 12B. In particular, when compared to the 10 mm diameter of the die chamber, the 3D GF without rebar showed about 15% shrinkage in diameter while the 3D rebar GF only showed about 2% shrinkage. Thus, the MWCNTs can possibly function as a reinforcing bar within the GF.

The physical integrity of the 3D rebar-10 GF was also tested by flushing the foam with DI water. Applicants observed that the 3D rebar-10 GF did not break under a DI water stream, even when directly hit by the stream.

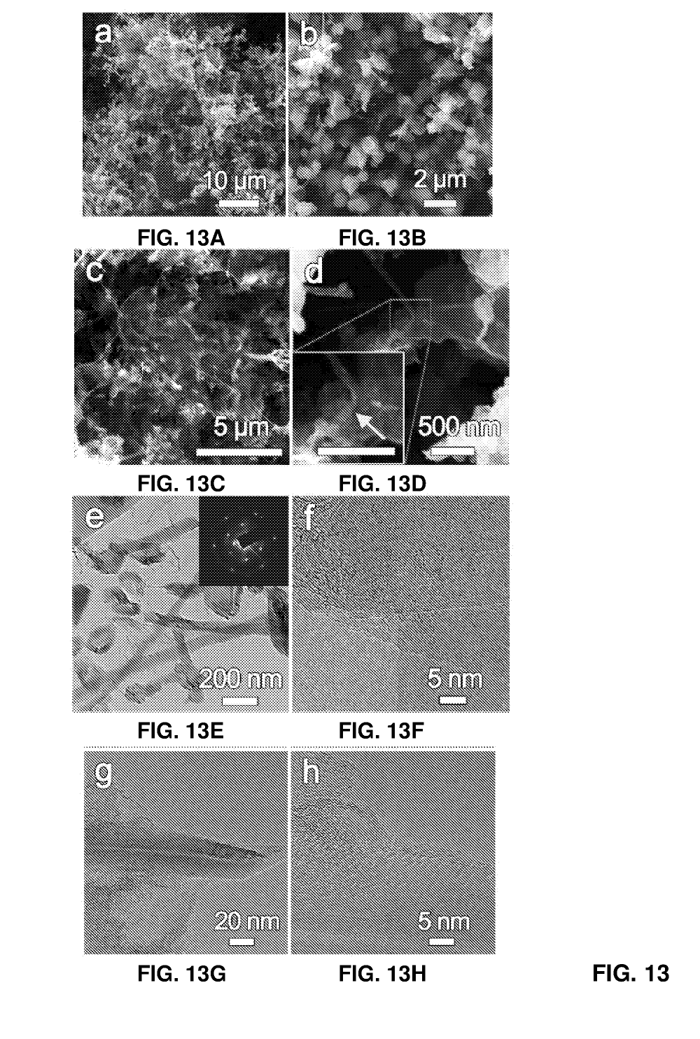

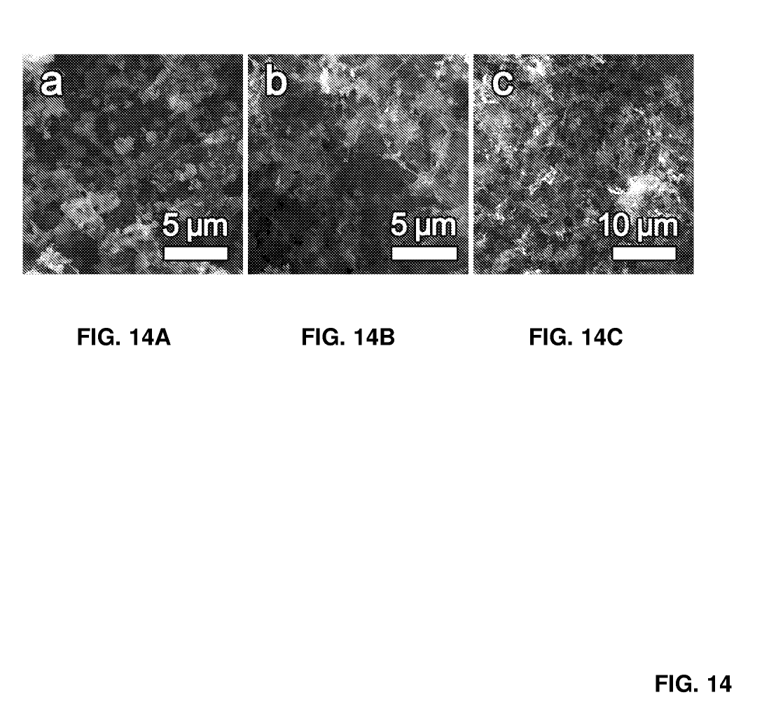

To investigate the morphology and function of MWCNTs in GFs as rebar, the 3D rebar-10 GF was characterized using a scanning electron microscope (SEM). As shown in the SEM images in FIGS. 13A-C and 14A-C, the 3D rebar GF consists of particle-like carbon shells, 2D graphene sheets, and MWCNTs. The carbon shells are connected by graphene sheets and MWCNTs.

Since graphene was grown on the surface and interface regions of the Ni particles, the sizes of the carbon shells are likely adjustable based on the Ni particle size used. The 3D rebar GFs are porous. The density of the 3D rebar-10 GFs is 0.16±0.01 g cm⁻³, which is calculated by measuring the mass and volume of the foams. Comparatively, the density of 3D GFs without rebar was 0.12±0.05 g cm⁻³, showing that the addition of MWCNTs leads to an increase in density (the density for 3D rebar-18 GFs is 0.20±0.01 g cm⁻³).

The porosity of the rebar GF was calculated using by using Equation 1.

$$θ = ( 1 - \frac{m}{Vd} ) \times 100 \% \qquad Eq . 1$$

In Equation 1, θ, m, V, and d represent the porosity, mass, volume, and the density of graphite (which is 2.09 to 2.23 g cm⁻³), respectively. The porosities of 3D GF and 3D rebar GFs are 90 to 96%, which is comparable with other reported carbon foams.

In 2D rebar graphene reported previously, the CNTs and boron nitride (BN) nanotubes were partially unzipped, and merged into 2D graphene with covalent connections. Similarly, in 3D rebar GF, as shown in FIG. 13D, the MWCNTs were stretched and partially connected to different parts of 3D graphene. The reinforced structure has an improved structural stability and better mechanical properties as compared to GFs without rebar, and is devoid of cracks or shrinkage, unlike GFs without rebar (FIG. 12A).

The transmission electron microscope (TEM) images in FIGS. 13E-H can provide a better understanding of the connections between MWCNTs and the graphene structure. Particle-like carbon shells, MWCNTs, and 2D graphene sheets can be clearly observed in FIG. 13E. The carbon shells are connected by graphene sheets and MWCNTs. The inset selected area electron diffraction (SAED) pattern shows a hybrid of a hexagonal single crystal signal from graphene and polycrystal rings, characteristic of carbon shells and MWCNTs.

A few-layered graphene structure can also be observed at the graphene edges in FIG. 13F. FIGS. 13G-H show the structure of rebar graphene where the graphene (highlighted in blue) and MWCNTs (highlighted in orange) are in direct contact, and possibly conjoined as studied previously by aberration correction TEM. As a general method, Applicants also tried to replace MWCNTs with multi-walled BN nanotubes (BNNTs).

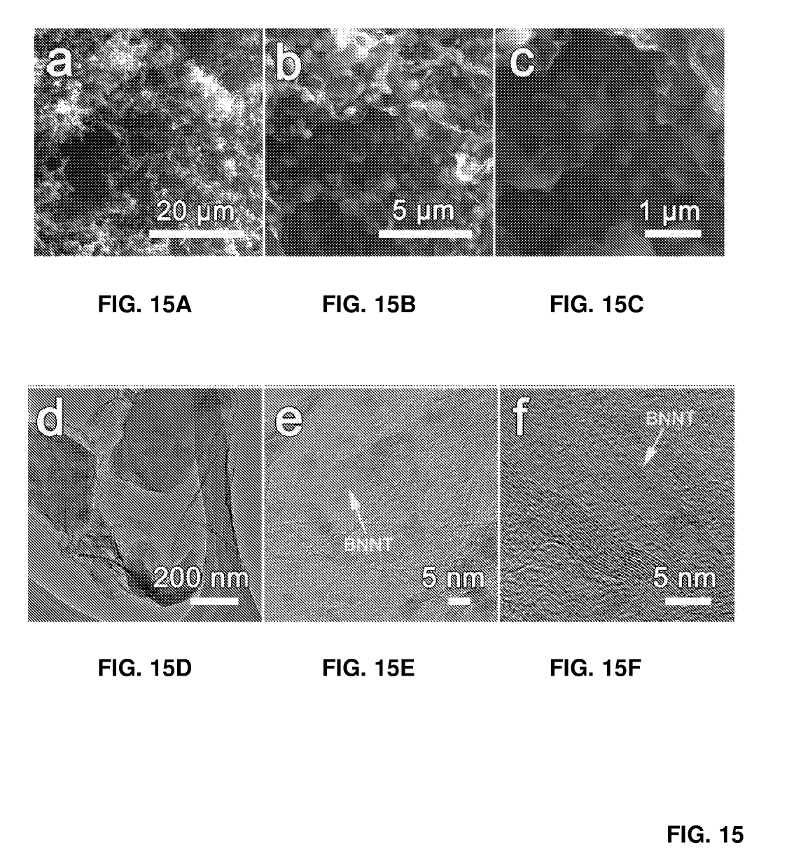

As shown in the SEM images in FIGS. 15A-C, the morphology of 3D BN rebar-2 GF are similar to that of 3D GF and 3D rebar GF. The materials consist of particle-like carbon shells and 2D graphene sheets. BNNTs on 2D graphene sheets can only be observed using TEM due to the small size of BNNTs (FIGS. 15D-F). The diameter of BNNTs is about 8 nm, as shown in FIGS. 15E-F. FIG. 15F highlights a double-walled BNNT. The BNNT are partially unzipped and form the rebar graphene structure that is similar to planar BNNT rebar graphene.

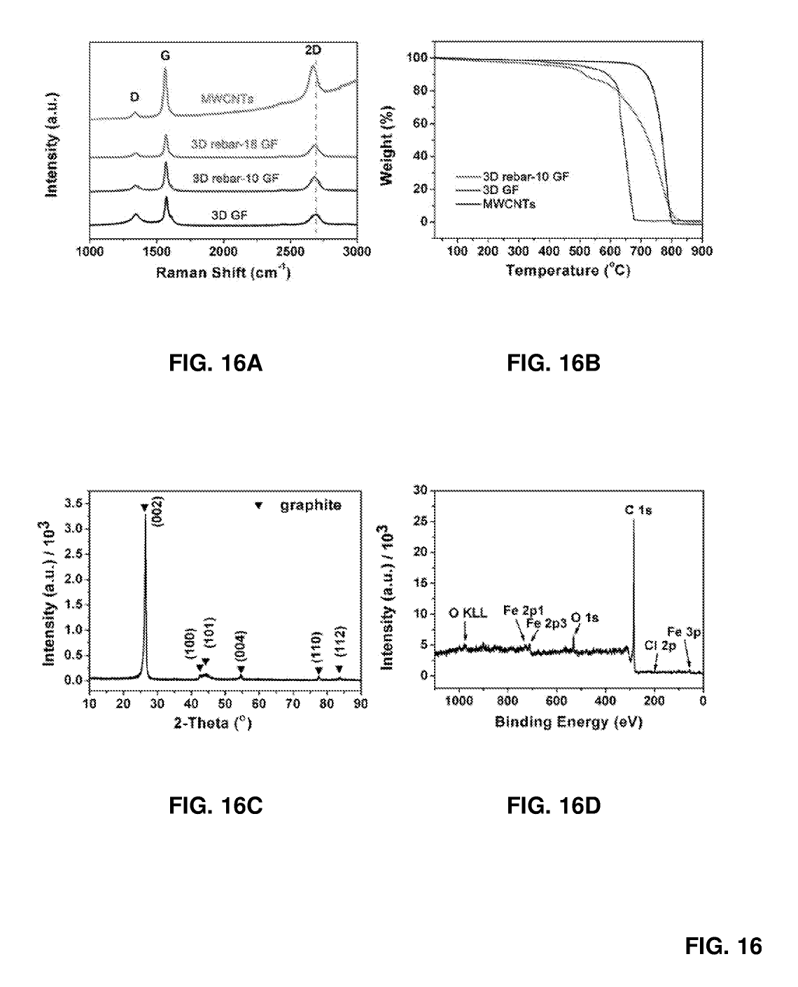

The quality, phase, and components of 3D rebar GF were investigated using Raman spectroscopy, thermogravimetric analysis (TGA), X-ray diffraction (XRD), and X-ray photoelectron spectroscopy (XPS). Raman spectra of GF samples in FIG. 16A display the modes of sp² carbon nanomaterials, showing the D (˜1350 cm⁻¹), G (˜1580 cm⁻¹) and 2D (˜2680 cm⁻¹) bands. The D/G ratios were 0.20 and 0.17 for 3D rebar-10 GF and 3D rebar-18 GF, respectively. These values are similar to those values found in 3D GF without rebar (0.27), indicating a similar structural quality in the 3D rebar GFs.

Since the unzipped part of MWCNTs is only the outer 1-3 layers of MWCNTs, which possess very small percentages of MWCNT full length and would create more defects, the unzipping of MWCNTs is not likely to affect the D/G ratios. The D/G ratio of MWCNTs is about 0.11, indicating a very high structural quality. Thus, when introducing more MWCNTs, the D/G ratio shows little decrease, as shown in FIG. 16A. The G/2D ratios of 2.08 (3D rebar-10 GF) and 1.76 (3D rebar-18 GF) are indicative of multi-layered graphene, which could contribute to the good strength of 3D rebar GFs. Moreover, the shift of the 2D band from 2688 cm⁻¹ (3D GF) to 2682 cm⁻¹ (3D rebar-10 GF) and 2679 cm⁻¹ (3D rebar-18 GF) can be observed, which indicate the introduction of different amounts of MWCNTs.

TGA testing was performed in air from room temperature (RT) to 900° C. with a heating rate of 10° C./min. As shown in FIG. 16B, only about 0.18 wt % of Ni remained after testing (3D rebar-10 GF), indicating that Ni can be removed almost completely by aqueous FeCl₃ etching. The ending temperature was about 820° C. for 3D rebar-10 GFs, which was higher than that of 3D GF (˜680° C.).

The introduction of MWCNTs improved the thermostability of GFs compared to the 3D GFs without rebar. The XRD and XPS results also demonstrate the low content of impurities in the 3D rebar GF, as shown in FIGS. 16C-D. All the peaks in the XRD pattern match well with the graphite phase, and no apparent Fe or Ni peaks can be observed. The small amount of Fe and Cl impurities that came from the FeCl₃ etching solution can be detected by XPS, as shown in FIG. 16D, and can be removed by further treatment. Thus, the array of characterization techniques demonstrated better thermal stability, high purity and good structural quality of the 3D rebar GFs.

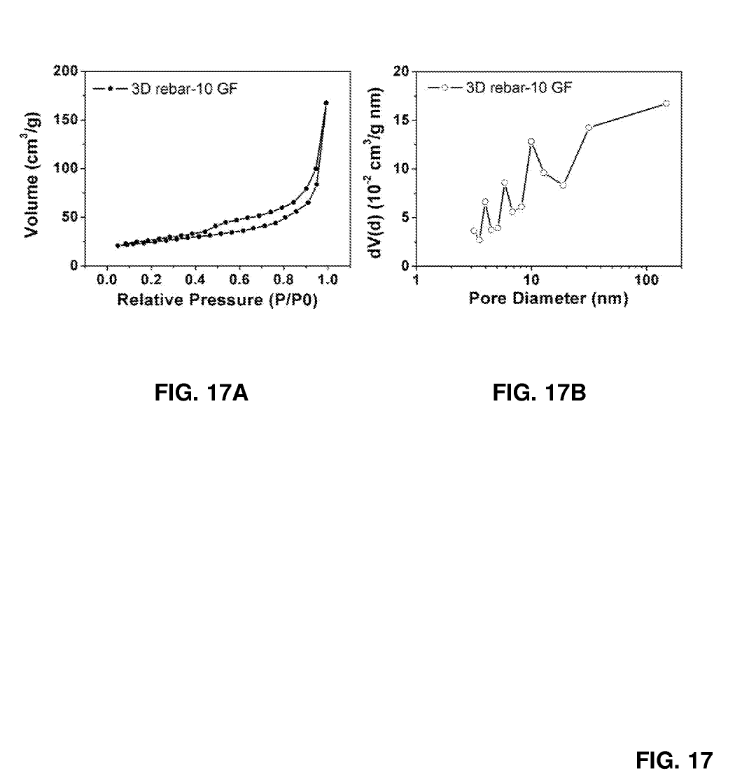

The pore structure and specific surface area of 3D rebar-10 GF were also tested. In particular, N₂ adsorption-desorption isotherms were measured to investigate the pore structure and specific surface area of 3D rebar-10 GF. The specific surface area was calculated using the BET method and the pore size distribution was determined by the BJH method. The BET specific surface area is about 80 m² g⁻¹ (FIG. 17A). The pore diameters are ˜3.9, 5.9, and 10 nm (FIG. 17B). The results indicate that the 3D rebar-10 GF is mesoporous

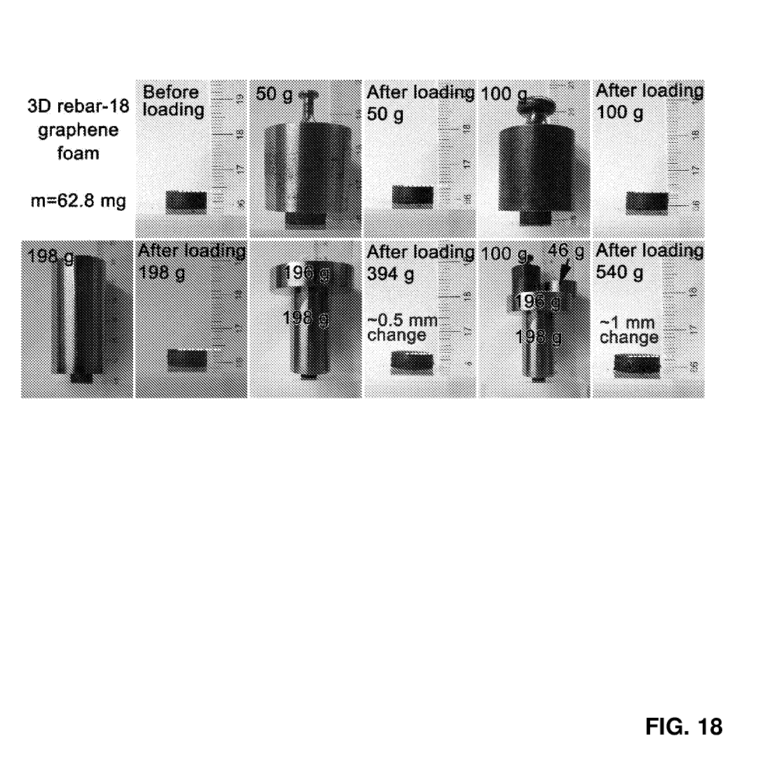

The mechanical properties of 3D rebar GFs were further investigated by loading different weights and also by dynamic mechanical analysis (DMA). Applicants observed that the 3D GF without rebar can only support about 150 times the foam's weight with rapid return of the full pellet height. In FIG. 18, Applicants repeated this experiment but instead used the 3D rebar-18 GF (˜62.8 mg). After loading a 50 g weight (i.e., more than 796 times the foam's weight), the rebar GF shows rapid return of the full pellet height. Even after loading a 198 g weight (i.e. 3,150 times the foam's weight), the foam can also rapidly return to the full pellet height.

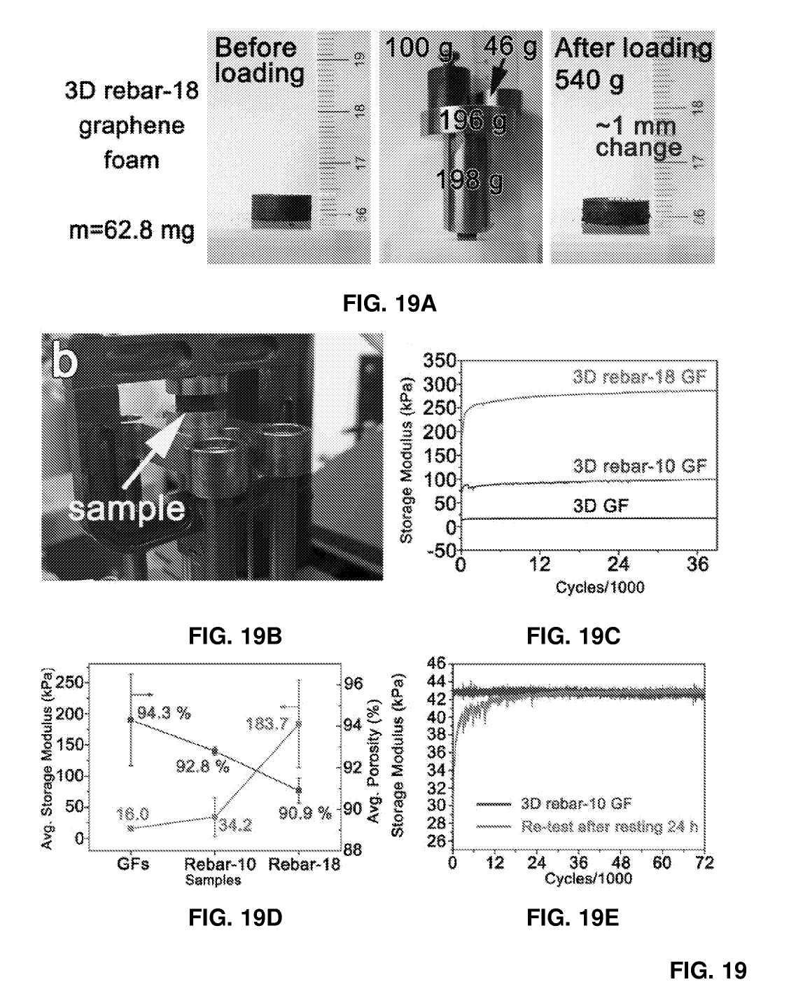

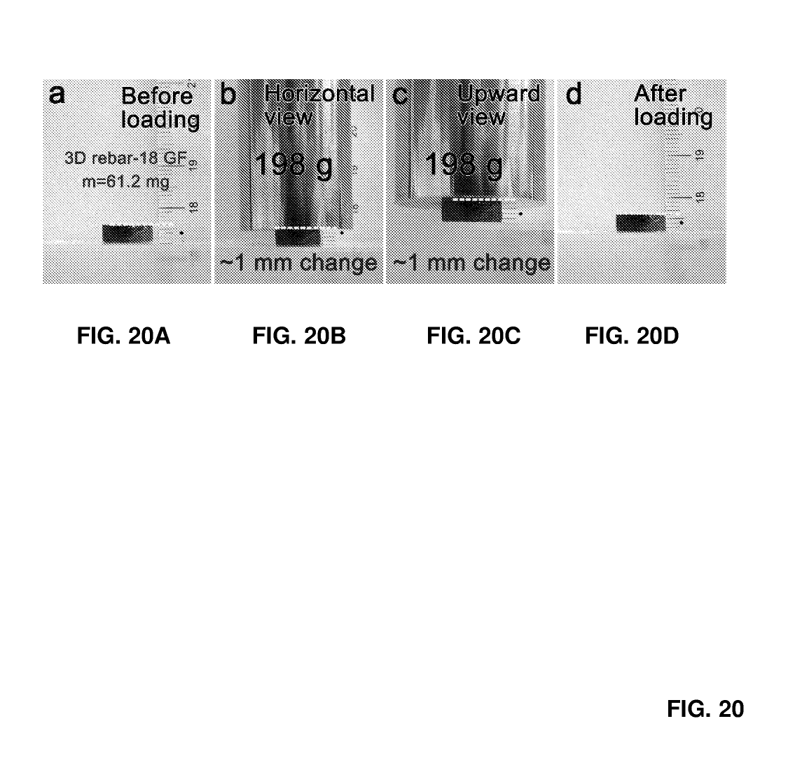

After loading a 540 g weight (FIGS. 19A and 18), which is more than 8,500 times the foam's weight, only a 25% height change (which corresponds to a total variation of ˜1 mm) was observed. In this case, the side wall of the 3D rebar-18 GF shows a small amount of collapse. However, in the case of loading a 198 g weight, the rebar-18 GF height was restored to full height after removing the weight (FIGS. 20A-D), showing that the GF is compressible and resilient yet much stronger than 3D GF without rebar.

Additional DMA tests were performed using the system shown in FIG. 19B under a constant frequency of 1 Hz with an amplitude of 20 μm (fixed displacement) by up to 72,000 cycles at room temperature. As shown in FIG. 19C, there was no collapse of 3D rebar GFs or 3D GFs, even after more than 36,000 cycles of testing. Such results indicate that the GFs have good structural stability, despite the presence or absence of rebar materials.

As also shown in the curves in FIG. 19C, the addition of MWCNTs increased the storage modulus in 3D rebar GF. The 3D rebar-18 GF reached 290.1 kPa, which is much higher than the stiffest sample of 3D rebar-10 GFs (101.0 kPa) and 3D GFs (17.7 kPa).

The average storage modulus also increased with an increasing amount of MWCNTs, as shown in FIG. 19D. The aforementioned results indicate that the storage modulus is controllable by adjusting the amount of MWCNTs. Compared to 3D GFs without rebar, the increase of storage modulus when adding MWCNTs is likely the result of the high quality MWCNT network.

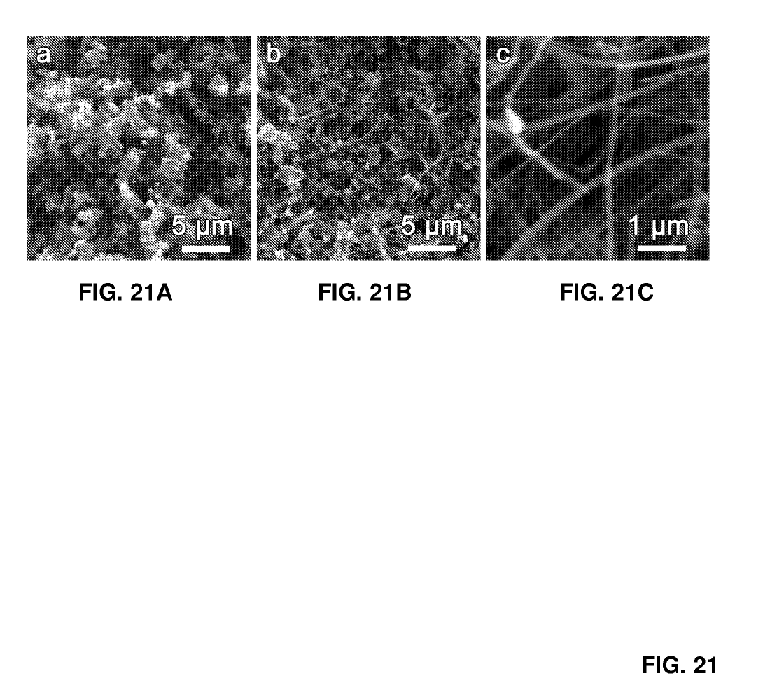

The MWCNTs act as a bridge and reinforcing bar to effectively support the structure of GFs, which contributes to its structural stability and resilience. Therefore, the higher content of MWCNTs in 3D rebar-18 GFs explains the better mechanical performance. The increased concentration of MWCNTs in this rebar GF can be observed in SEM images, as presented in FIGS. 21A-C. With the increase of MWCNT content, the standard deviation of the storage modulus also increased, which is likely due to the less-uniform distribution of MWCNTs at higher loadings. As shown in FIGS. 21A-B, the amount of MWCNTs in rebar-18 GFs is higher than that in rebar-10 GFs, which can be observed in the images. MWCNTs can form a good network in the 3D space of GF. Therefore, the rebar-18 GFs, with better MWCNT networks, present better mechanical performance. As shown in FIG. 21C, the diameter of raw MWCNTs is about100 nm.

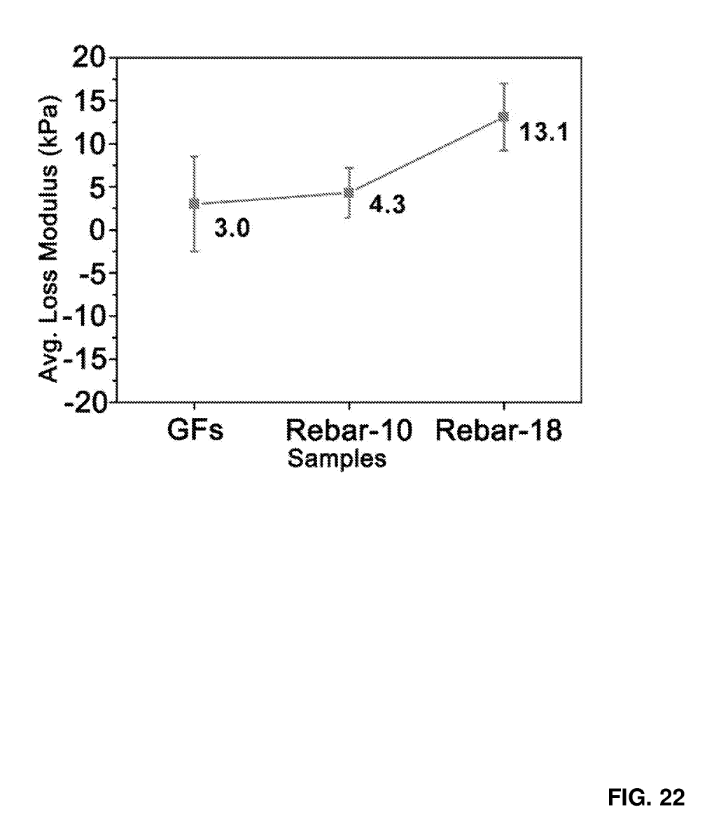

The average loss modulus of the samples was also tested, as shown in FIG. 22. With the increase of MWCNT content, the loss modulus also increased due to the increase of the friction or sliding between MWCNT and graphene sheets during the DMA testing.

Furthermore, as shown in FIG. 19D, the storage modulus was affected by the porosity of the materials. The porosity decreased when increasing the amount of MWCNTs. In addition, to further demonstrate the structural stability of 3D rebar GF, Applicants re-tested the same 3D rebar-10 GF sample after resting for 24 hours. As shown in FIG. 19E, after a long time of testing (1,200 minutes) in the 1^{st} analysis, no apparent collapse can be detected. After resting for 24 hours, there was no apparent change in the value of the storage modulus, as well as no apparent collapse after another 72,000 cycles of testing.

The aforementioned results demonstrate the good structural stability of the rebar GF. The beginning part of the increased storage modulus in the red curve in FIGS. 19C and 19E were likely observed because the DMA system needed time to stabilize since the initial loading force varied when loading different samples onto the testing stage.

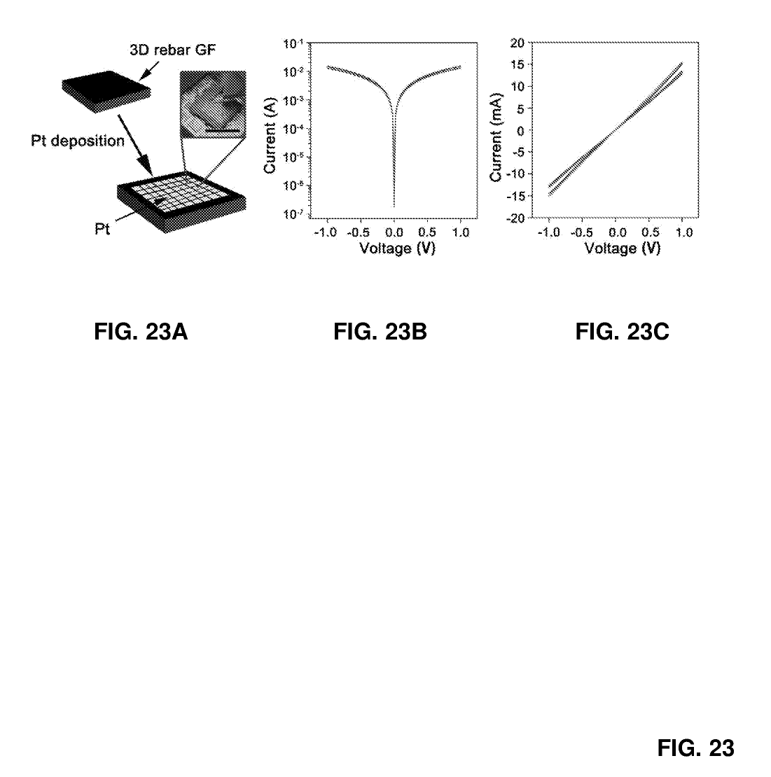

Conductivity of 3D rebar GFs were directly measured through an experimental setup illustrated in FIG. 23A. Using a shadow mask evaporation method, platinum contact pads (250 μm×250 μm) were deposited onto 3D rebar-10 GF. The distance between the contacts is 120 μm.

FIG. 23B shows the room temperature in-plane electrical conductivity of a 20-μm-thick 3D rebar GF. The linear current and voltage curve in FIG. 23C indicates ohmic contact of the platinum with the rebar GF. The electrical transport characteristics provide an average electrical conductivity of 3D rebar GF (σ=I×l/V×A=15.5±0.4 S cm⁻¹), which is comparable with that of 3D GFs without rebar (12.3±2.7 S cm⁻¹), where I, l, V and A are the measured current, length of channel, applied voltage and cross-sectional area of 3D GF, respectively. The conductivity is also comparable with other prior results, as summarized in Table 2.

TABLE 2
A comparison of electrical conductivities
of various materials with 3D rebar-10 GF.

| | Conductivity |
|---|---|
| Materials | (S/cm) |
| Graphene aerogels | 1 |
| Graphene assemblies with physical cross-links alone | 0.005 |
| Graphene paper by pressing graphene aerogel | 18 |
| 3D embossed chemically modified graphene | 12.4 |
| Graphene foam grown by CVD method on Ni foam | 10 |
| Activated RGO films | 58 |
| Bulk elastic carbon foam carbonized at 1800° C. | 2.1 |
| rGO/CNTs film | 25.6 |
| 3D rebar-10 GF | 15.5 |

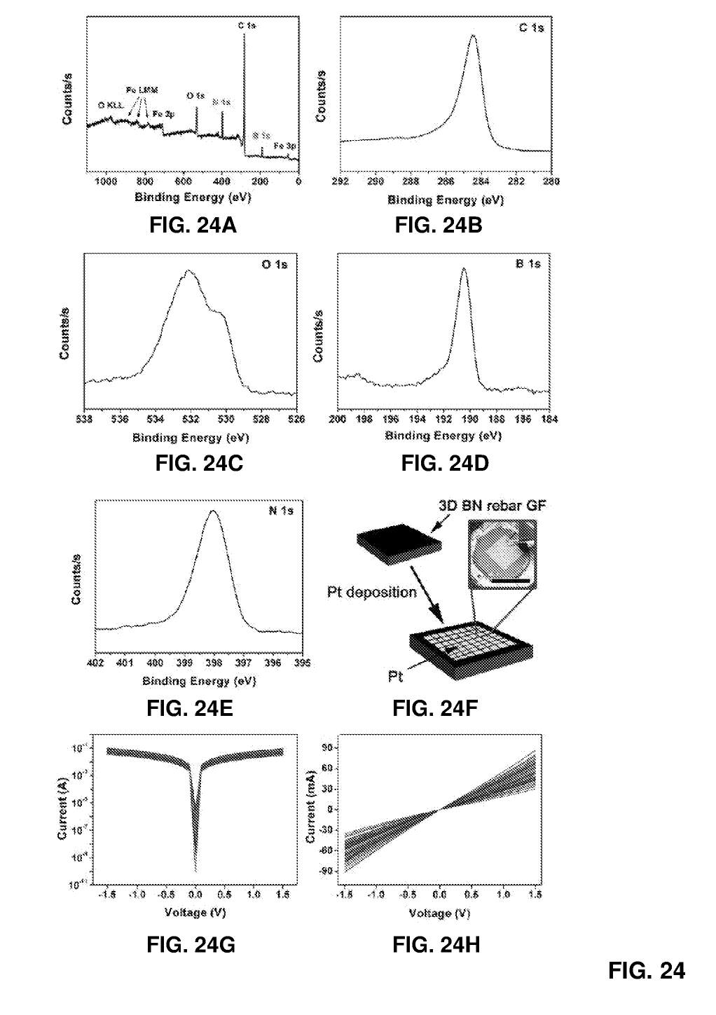

The maximum value of electrical conductivity of 3D rebar-10 GF is 21.8 S cm⁻¹, which is higher than that of 3D GFs without rebar (13.8 S cm⁻¹). When changing MWCNTs to BNNTs, the conductivity decreased to ˜1.4 S cm⁻¹ due to the non-conductive nature of BNNTs, as summarized in FIG. 24. This comparison demonstrates that MWCNTs can act as bridges or channels for electron transport.

The BNNTs can be detected in 3D BN rebar GFs using XPS. As shown in FIGS. 24A-E, the contents of B is and N is are about 9 at % and about 8 at %, respectively. As with 3D rebar GFs using MWCNTs, little Fe impurities can be detected (˜1.3 at %). As shown in FIGS. 24F-H, the conductivity of 3D BN rebar-2 GF was also directly tested. Using a shadow mask evaporation method, Pt contact pads (250 μm×250 μm) were deposited onto 3D BN rebar-2 GF. The distance between the contacts is 120 μm, as shown in FIG. 24F. FIG. 24G shows the RT electrical conductivity of a 20-μm-thick 3D BN rebar-2 GF. The linear current and voltage curve in FIG. 24H indicates ohmic contact of the platinum with the sample. The average and maximum values of electrical conductivity of 3D BN rebar-2 GF are about 0.9 and about 1.4 S cm⁻¹, respectively. The decrease of conductivity is due to the non-conductive nature of BNNTs.

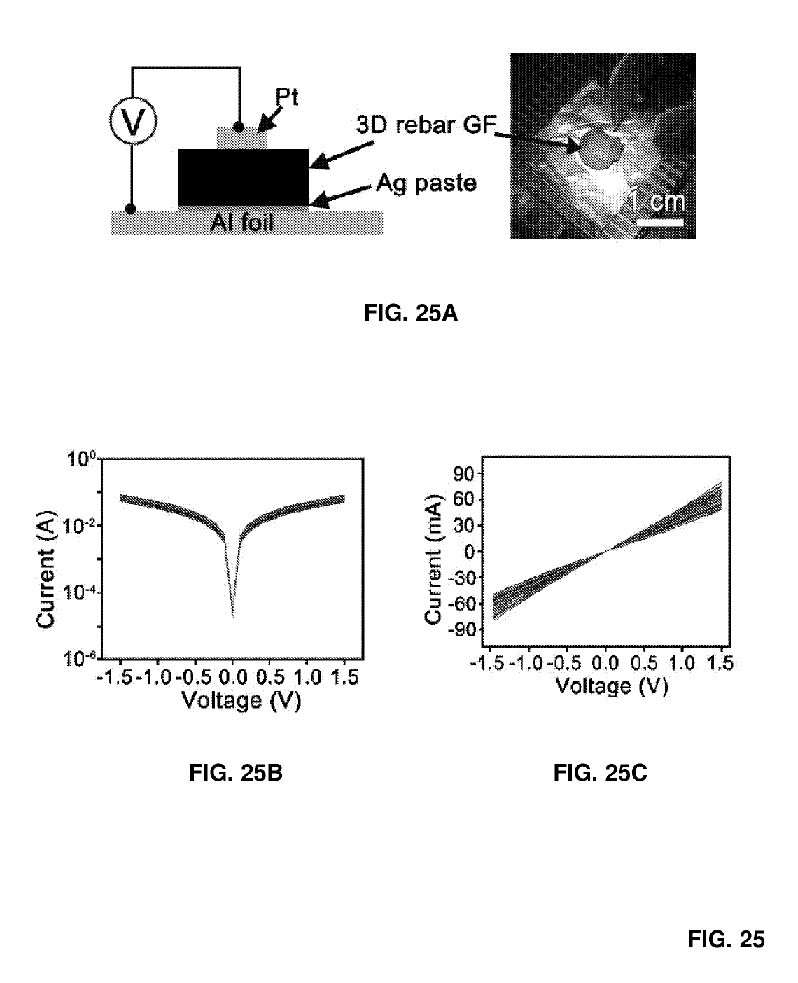

Next, by utilizing the experimental setup in FIG. 25A, the cross-plane conductivity of 3D rebar-10 GF was directly measured. Using a shadow mask evaporation method, platinum contact pads (250 μm×250 μm) were deposited onto 3D rebar-10 GF. The foam was pasted on Al foil by Ag paste. The thickness of 3D rebar-10 GF was ˜0.89 mm. FIG. 25B shows the RT cross-plane electrical conductivity of the sample. The linear current and voltage curve in FIG. 25C indicates ohmic contact of the platinum and Ag paste with the rebar GF. The electrical transport characteristics provide an average electrical conductivity of 9.64±1.18 S cm⁻¹, which is smaller but comparable with in-plane conductivity of 15.5 S cm⁻¹ since the channel length of testing is the full height of the foam (˜0.89 mm), which is much larger than the in-plane testing channel length of 120 μm. The maximum value of cross-plane electrical conductivity of 3D rebar-10 GF is 12.08 S cm⁻¹. The average cross-plane conductivity was 9.64±1.18 S cm⁻¹, which is smaller but comparable with in-plane conductivity of 15.5 S cm⁻¹.

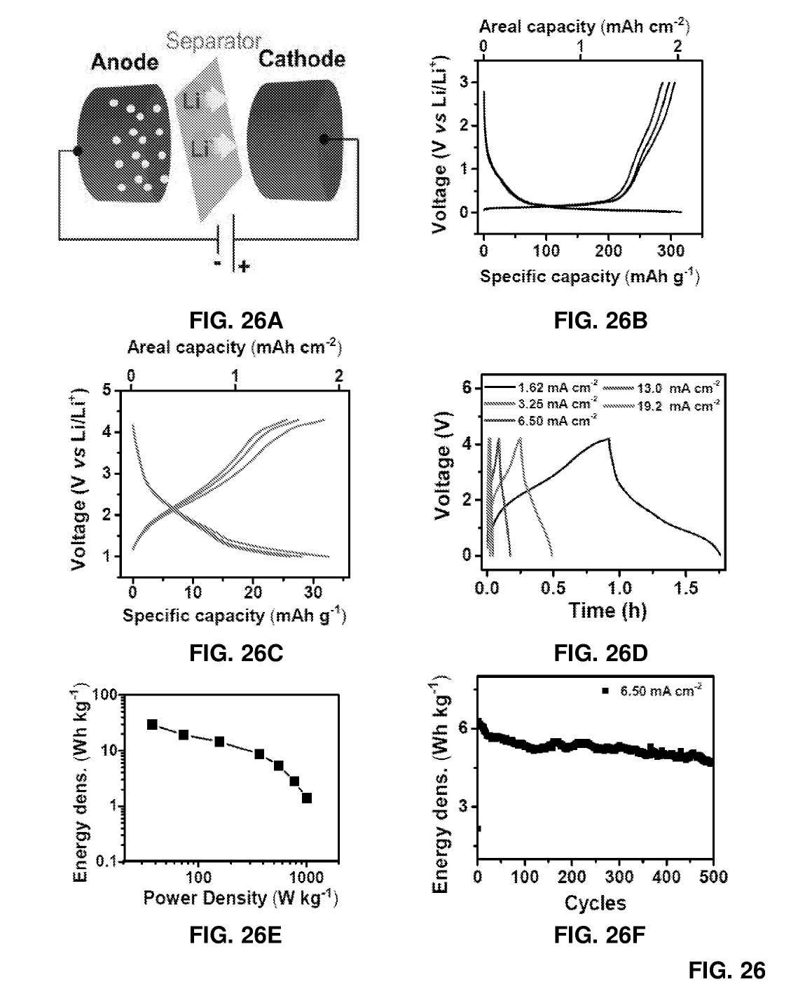

Since the 3D rebar GF demonstrates high conductivity for a carbon material, Applicants tested the GF without modifications as an electrode in LIC applications (FIG. 26). Electrodes (total area=0.5 cm²) were prepared directly from 3D rebar-10 GFs with different mass loadings (6 to 60 mg cm⁻²). The electrodes were binder-free and current collector-free, meaning that 100% of the active material is composed of 3D rebar-10 GF. No current collector was needed due to the high conductivity of the GF. The tests were first conducted in half-cells (with Li foil as both the reference and counter electrode) to assess the GF specific capacity as an anode and cathode, having the 3D rebar-10 GF as the working electrode. The first voltage range was between 0.01 to 3.0 V to test the rebar GF as an anode, while the second voltage range was between 1 and 4.3 V to test the rebar GF as a cathode.

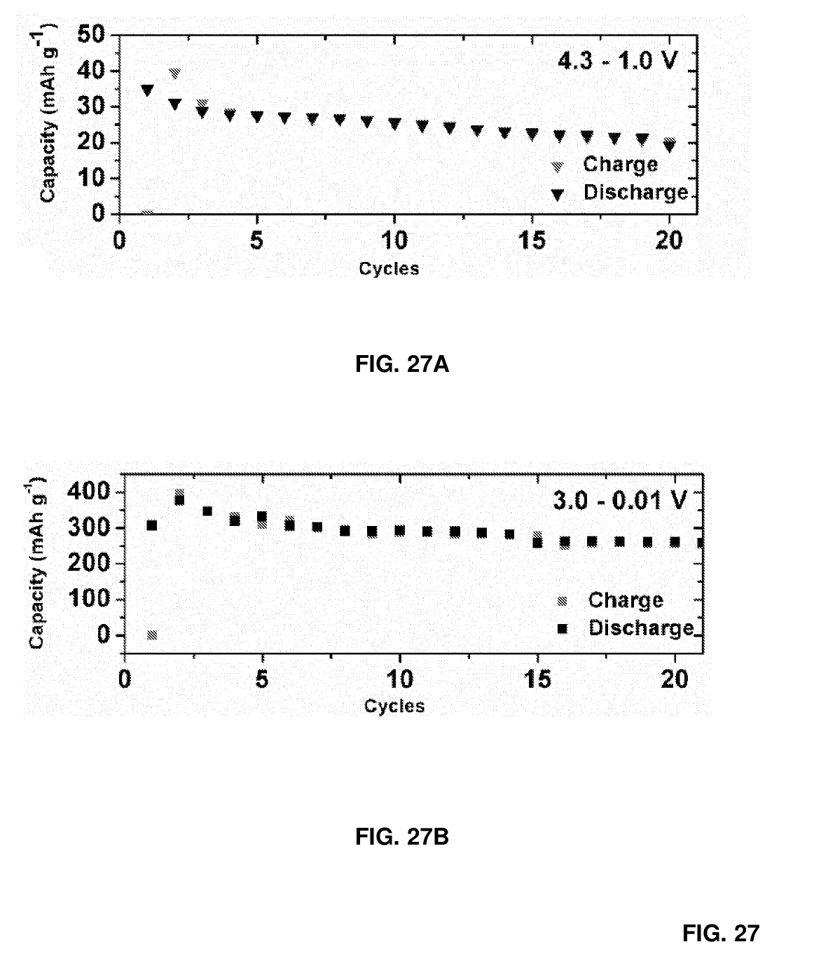

FIG. 26A shows a scheme of the LIC during discharge. FIG. 26B shows the galvanostatic charge-discharge curves of 3D rebar GF tested as an anode in the range of 0.01 and 3.0 V, where the mass loading for the anode was 6.4 mg cm⁻². The full mass of 3D rebar GF was included to calculate the gravimetric capacity. A capacity close to 320 mAh g⁻¹ was achieved, which is similar to graphite's theoretical capacity (372 mAh g⁻¹). The results indicate that all graphitic structures (including the GF and MWCNT) participate reversibly in the lithiation reaction without breaking the structure of the rebar GF. Moreover, the structure of the rebar GF is robust to reversible and repetitive lithiation reactions (FIGS. 27A-B). The charge-discharge curves show a very flat voltage profile at approximately 0.2 V, and significant areal capacity is achieved (˜2 mAh cm⁻²) caused by the high mass loading.

Compared to the anode, the cathode was tested in the range of 1 to 4.3 V (FIG. 26C), delivering a total gravimetric capacity of approximately 30 mAh g⁻¹, and using a very high mass loading of ˜60 mg cm⁻². This capacity is comparable with unmodified graphene cathodes. The lower capacity as well as the different voltage profile of the cathode using an all-carbon 3D rebar GF indicates a different mechanism of Li storage, generally attributed to reversible redox reactions of Li⁺ with defects or oxidized groups which can increase significantly the capacity. In the curves, a flat range is found between 2.5 and 1.5 V (vs Li/Li⁺ pair). Also, significant areal capacity is achieved (˜2 mAh cm⁻²) due to the high mass loading of 3D rebar-10 GF.

For assembly of the full LIC, the anodes and cathodes were pre-tested as half-cells for 5 cycles, disassembled and recombined into a full device. The cathode testing was finished at the un-lithiated state, while the anode testing was finished at the lithiated state. To match the total capacity, the mass ratio of about 1:10 was used between the anode and cathode, respectfully, and 100% of the active materials were 3D rebar-10 GF. The full capacitor was tested between 0.01 and 4.2 V. As shown in FIG. 26D, due to the high mass loading per area, very high current densities per area were achieved (more than 3 mA cm ²) with low current densities per mass of combined anode plus cathode (less than 0.05 A g⁻¹). The LIC showed a large voltage window between 0.01 and 4.2 V.

As shown in the Ragone plot of the 3D rebar-10 GF LIC in FIG. 26E, the LIC produced with only 3D rebar-10 GF achieved 32 Wh kg⁻¹ of energy density. This energy density is comparable with similar LICs in the literature (30 Wh kg⁻¹). However, the 3D rebar GF have higher mass loading (i.e., up to 60 mg cm ²) than typical electrodes (i.e., less than 2 mg cm⁻²). The reversible reactions in the anodes and cathodes indicate good structural stability of the LIC.

As shown in FIG. 26F, the 3D rebar GF can support long range cycling at high current densities due to the robust structure. The curve shows a 78% energy density retention after 500 cycles at 6.50 mA cm ². Moreover, the 3D rebar GF electrodes could host other materials, which could increase the gravimetric capacity or alter the voltage profile to enable much higher energy density devices. The application presented in FIG. 26 indicates that 3D rebar GF can act as a stable and efficient 3D electrode for other similar applications, such as lithium-ion or lithium-air batteries.

In sum. Applicants demonstrate in this Example the design of a free-standing and robust 3D rebar GF by a powder metallurgy template method. MWCNTs, which act as rebar by partial bonding with graphene and the carbon shells in the foam, can toughen and strengthen 3D GF. Thus, compared with 3D GF, the 3D rebar GF shows higher thermal stability, storage modulus, strength, structural stability and conductivity.

By changing the content of MWCNTs, the mechanical properties and porosity of 3D rebar GF was controllable. The 3D rebar GF also showed stable performance as an electrode in LICs, making it possible to use these continuous foam electrodes as conductive and binder-free matrices in electrical devices.

### EXAMPLE 2.1

### Preparation of MWCNTs Dispersion

MWCNTs in this Example functioned as rebar in the in situ generated 3D GF structures. The MWCNTs also worked as covalent or π-π stacked bridges between graphene and carbon shell structures generated by the Ni template matrix.

MWCNTs (AZ Electronic Materials USA Corp. 2699-64C, 1 mg/mL) and Pluronic F127 surfactant (BASF Corp., 583106, 1 mg/mL) were mixed in deionized (DI) water. The mixture was sonicated using a tip-sonicator (Misonix Sonicator 3000) at ˜100 W. After 20 minutes, a MWCNTs dispersion was obtained.

### EXAMPLE 2.2

### Preparation of 3D Rebar GFs

3D rebar GFs were synthesized by a powder metallurgy template method with Ni powders (APS 2.2-3.0 μm, Alfa Aesar #10255) and sucrose as templates and carbon source, respectively. MWCNTs are the reinforcing bars in the foams. The procedures for preparing 3D foams were described in Example 1. Briefly, 3 g of Ni powders and 0.5 g of sucrose were mixed in 150 mL DI water.

Under mechanical stirring (300 RPM), a specific amount of MWCNTs dispersion was added into the mixture. For a 25 mL dispersion that contains 25 mg MWCNTs and 25 mg surfactant (the mass percentage of C atom in the surfactant is about 30%), the MWCNT content related to the total carbon atomic mass (sucrose+MWCNTs+surfactant) was about 10%. This sample is referred to as 3D rebar-10 GF. Similarly, samples prepared using a 50 mL dispersion that contains 50 mg MWCNTs and 50 mg surfactant was named 3D rebar-18 GF, meaning that the MWCNTs content related to the total carbon mass was about 18%.

The mixtures were heated at 80° C. to evaporate water under mechanical stirring. Next, the hybrid powders were dried at 75° C. in a vacuum oven (˜2 mmHg) overnight. After being ground using a mortar and pestle, the hybrid powders were pressed into pellets at a pressure of ˜1120 MPa for 5 minutes using a steel die. The pellets were then loaded into a quartz tube furnace to grow graphene under H₂/Ar (200 sccm/500 sccm) at a chamber pressure of about 9 Torr.

The temperature was increased from room temperature to 1,000° C. at a heating rate of 10° C. min⁻¹, and the pellets were further annealed at 1,000° C. for 30 minutes. After growing, the pellets were removed rapidly from the hot region using a magnetic extraction boat, and then cooled to room temperature. Finally, the Ni pellets were etched in 1 M FeCl₃ aqueous solution (200 mL, refreshed with new solution every day until no color change) for 1 week, and then transferred into DI water. The foams were purified in DI water for 1 week (200 mL, refreshed with DI water every day until no color change) and dried using a CPD (Supercritical Automegasamdri-915B) to obtain free-standing 3D rebar GFs.

For comparison, 3D rebar GFs using boron nitride nanotubes (BNNTs) were also prepared. The preparation procedures were the same as those of 3D rebar GFs prepared using MWCNTs. However, MWCNTs were replaced with BNNTs.

The BNNT dispersion was prepared by using 5 mg of BNNTs with 10 mg of Pluronic F127 surfactant and 10 mL of DI water. The sample is referred to as 3D BN rebar-2 GF, indicating that the BN content is ˜2 wt %.

### EXAMPLE 2.3

### Characterization

The morphology of 3D rebar GFs was determined using SEM (FEI Quanta 400 ESEM) operated at 10 kV and a high-resolution 200 kV JEOL JEM-2100F TEM. The XRD patterns were taken using a powder X-ray diffraction system (Rigaku D/Max Ultima II, Cu Kα radiation). Raman spectra were collected with a Renishaw inVia Raman Microscope RE04 using a 532 nm laser. The TGA testing were carried out from room temperature to 900° C. in air using a Q-600 Simultaneous TGA/DSC from TA Instruments. Nitrogen adsorption-desorption isotherms were measured at 77 K by a Quantachrome Autosorb-3b Brunauer-Emmett-Teller (BET) Surface Analyzer.

The specific surface area was calculated using the BET method and the pore size distribution was determined by the Barrett-Joyner-Halenda (BJH) method. The XPS spectra were taken on a PHI Quantera SXM scanning X-ray microprobe with a 100 μm beam size and a 45° take off angle. Electrical conductivity was analyzed with an Agilent B1500A semiconductor parameter analyzer using a customized DC probe station by a two-probe configuration measurement method under ambient atmosphere and room temperature. Platinum contact pads with a size of 250 μm×250 μm were deposited onto a 20-μm-thick 3D rebar GF using shadow mask evaporation. The distance between the contacts was 120 μm.

The mechanical properties were tested and analyzed using a DMA Q800 system from TA Instruments. Tests were carried out under a constant frequency of 1 Hz with an amplitude of 20 μm (fixed displacement) by up to 72,000 cycles at room temperature.

Electrochemical characterizations were made using 2032 coin cells for both half-cell tests (with Li foil as both reference and counter electrode) and full lithium ion capacitors, and tested using a MTI Battery Analyzer. Electrodes (total area 0.5 cm²) were prepared directly from 3D rebar GFs with different mass loadings (6 to 60 mg cm ²). Celgard K2045 membranes were used as separators. The electrolyte was 1.0 M of LiPF₆ (lithium hexafluorophosphate) in a mixture 50/50 (v/v) of ethylene carbonate:diethyl carbonate (EC:DEC) for both half-cell and full lithium ion capacitors. The anode half-cells were tested between 0.01 and 3.0 V, while the cathodes half-cells were tested between 1 and 4.3 V.

For assembly of a full lithium ion capacitor, the anode and cathode were previously tested as half-cells for 5 cycles, disassembled and recombined in a full device. The cathode testing was finished at the un-lithiated state, while the anode testing was finished at the lithiated state. The mass ratio was approximately 1:10 (anode:cathode). The full capacitor was tested between 0.01 and 4.2 V. All assemblies were prepared in an Ar-filled glove box with O₂ and H₂O content below 3 ppm.

### EXAMPLE 3

### Preparation of Three-Dimensional Graphene Foams with Controllable Porosities

In this Example, the methods described in Examples 1-2 were utilized to form three-dimensional graphene foams (3D GFs) with controllable porosities. In particular, the weight pressure applied to the catalytic materials (i.e., Ni foams) and carbon sources during the combining steps were varied in order to control the porosity of the 3D GFs.

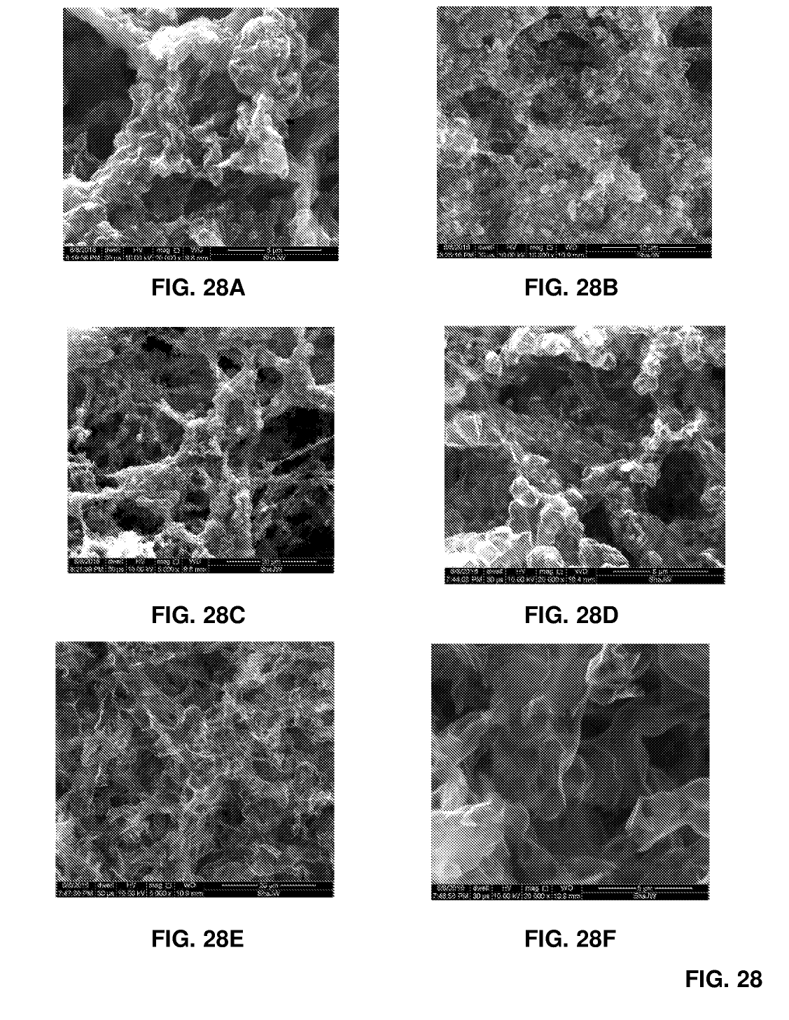

For instance, pellets containing the catalytic materials and carbon sources were pressed under a pressure of 0.5 tons on a 1 cm diameter die. The pellets were also pressed by hand in a die. After removing the Ni template and drying, the samples were characterized by scanning electron microscopy (SEM). The SEM images are shown in FIG. 28.

In particular, FIGS. 28A-C show the SEM images of the 3D GFs that were pressed by hand. The SEM images show large and porous amounts of graphene-like skeleton and limited amounts of carbon shells.

FIGS. 28D-F show the SEM images of the 3D GFs that were pressed by 0.5 tons of pressure. The SEM images show 3D GFs that are less porous than the 3D GFs in FIGS. 28A-C.

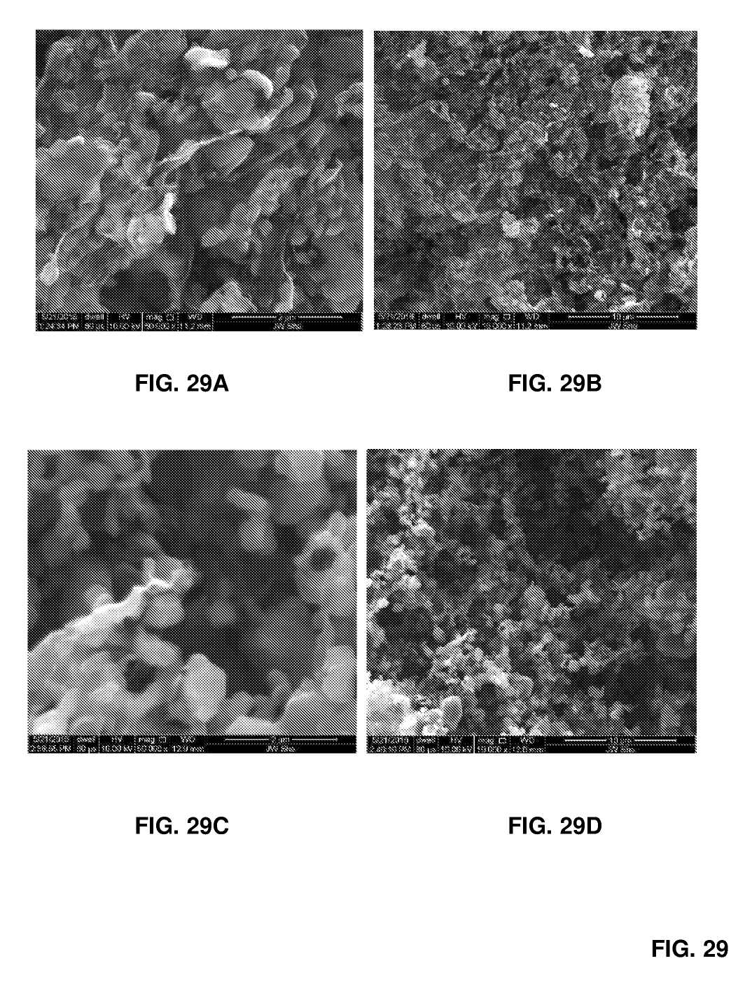

In another experiment, pellets containing the catalytic materials and carbon sources were pressed under pressures of 0.25 tons and 6 tons. After removing the Ni template and drying, the samples were characterized by SEM. The SEM images are shown in FIG. 29.

In particular, FIGS. 29A-B show the SEM images of the 3D GFs that were pressed by 0.25 tons of pressure. FIGS. 29C-D show the SEM images of the 3D GFs that were pressed by 6 tons of pressure. The SEM images indicate that 3D GFs that were formed under higher pressures were less porous than the 3D GFs that were formed under lower pressures.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making a three-dimensional material, said method comprising:
combining a catalytic material with a precursor material;
forming the three-dimensional material from the precursor material in the presence of the catalytic material,
wherein the three-dimensional material is formed on surfaces and internal cavities of the catalytic material, and
wherein the three-dimensional material comprises a plurality of connected units.

2. The method of claim 1, wherein the combining occurs by a method selected from the group consisting of mixing, stirring, grinding, pressing, cold-pressing, die casting, molding, heating, spin coating, sonication, dispersion, drop-casting, spray coating, dip coating, physical application, vapor-coating, sublimation, blading, inkjet printing, screen printing, direct placement, dissolution, filtration, thermal evaporation, hydrothermal treatment, and combinations thereof.

3. The method of claim 1, wherein the combining comprises a first step of mixing the catalytic material with the precursor material, and a second step of pressing the mixed catalytic material and precursor material.

4. The method of claim 1, wherein the catalytic material is selected from the group consisting of Cu, Ni, Co, Fe, Pt, Au, Al, Ag, Cr, Mg, Mn, Mo, Rh, Ru, Si, Ta, Ti, W, U, V, Zr, powders thereof, foils thereof, vapor deposited metals thereof, reduced forms thereof, oxidized forms thereof, associated alloys thereof, and combinations thereof.

5. The method of claim 1, wherein the catalytic material is in the shape of particles.

6. The method of claim 1, wherein the precursor material is selected from the group consisting of carbon sources, non-carbon sources, metal sources, chalcogenide sources, metal chalcogenide sources, boron containing compounds, nitrogen containing compounds, carbon nanotubes, graphene nanoribbons, boron nitride nanotubes, chalcogenide nanotubes, metal chalcogenide nanotubes, nanoparticles, nanorods, nanowires, carbon onions, solid precursor materials, liquid precursor materials, gaseous precursor materials, and combinations thereof.

7. The method of claim 1, wherein the precursor material comprises a carbon source.

8. The method of claim 7, wherein the carbon source is selected from the group consisting of alkanes, alkenes, alkylenes, alkynes, polymers, non-polymeric carbon sources, raw carbon sources, small molecules, organic compounds, carbohydrates, sugars, polysaccharides, carbon oxides, carbon nitrides, carbon sulfides, lignin, asphalt, crude oil, bitumen, coke, coal, carbon nanotubes, graphene nanoribbons, graphene quantum dots, surfactants, and combinations thereof.

9. The method of claim 1, wherein the precursor material comprises carbon nanotubes.

10. The method of claim 9, wherein the carbon nanotubes are selected from the group consisting of functionalized carbon nanotubes, polymer wrapped carbon nanotubes, surfactant wrapped carbon nanotubes, metallic carbon nanotubes, semi-metallic carbon nanotubes, single-walled carbon nanotubes, double-walled carbon nanotubes, multi-walled carbon nanotubes, ultra-short carbon nanotubes, and combinations thereof.

11. The method of claim 1, wherein the precursor material comprises a metal source.

12. The method of claim 11, wherein the metal source comprises metals selected from the group consisting of Mo, W, Bi, Hf, Ga, Ge, Ta, Sn, Zn, Cd, Pb, B, Nb, Zr, Si, hydrides thereof, oxides thereof, chalcogenides thereof, and combinations thereof.

13. The method of claim 11, wherein the metal source comprises metal hydrides.

14. The method of claim 1, wherein the precursor material is functionalized with a plurality of functional groups.

15. The method of claim 14, wherein the functional groups are selected from the group consisting of alkyl groups, alcohol groups, carboxyl groups, carbonyl groups, alkoxy groups, aryl groups, aryl sulfonyl groups, polymers, sulfur groups, organic compounds, surfactants, graphene quantum dots, carbon quantum dots, inorganic quantum dots, nanoparticles, and combinations thereof.

16. The method of claim 1, wherein the formation of the three-dimensional material from the precursor material comprises connecting the precursor materials to one another.

17. The method of claim 1, wherein the formation of the three-dimensional material from the precursor material comprises growing the three-dimensional material from the precursor material.

18. The method of claim 1, wherein the formation of the three-dimensional material from the precursor material occurs by a method selected from the group consisting of chemical vapor deposition, heating, annealing, and combinations thereof.

19. The method of claim 1, further comprising a step of separating the catalytic material from the three-dimensional material.

20. The method of claim 19, wherein the separating occurs by a method selected from the group consisting of etching, dissolution, extraction, physical separation, catalytic material oxidation, washing, and combinations thereof.

21. The method of claim 1, wherein the plurality of connected units of the three-dimensional material are selected from the group consisting of graphene, carbon shells, phosphorenes, boron nitrides, metal layers, connected precursor materials, hybrid materials thereof, composites thereof, and combinations thereof.

22. The method of claim 1, wherein the plurality of connected units of the three-dimensional material comprise graphene.

23. The method of claim 22, wherein the graphene is selected from the group consisting of monolayer graphene, bilayer graphene, multilayer graphene, polycrystalline graphene, pristine graphene, single-crystal graphene, graphite, doped graphene, graphene oxide, functionalized graphene, and combinations thereof.

24. The method of claim 1, wherein the plurality of connected units of the three-dimensional material comprise metal layers.

25. The method of claim 24, wherein the metal layers comprise MXₙ,
wherein M is selected from the group consisting of Mo, W, Bi, Hf, Ga, Ge, Ta, Sn, Zn, Cd, Pb, B, Nb, Zr, Ti, W, Nb, Si and combinations thereof;
wherein X is selected from O, C, S, N, Se, Te, and combinations thereof; and
wherein n is 1, 2 or 3.

26. The method of claim 1, wherein the plurality of connected units of the three-dimensional material comprise hybrid materials.

27. The method of claim 26, wherein the hybrid materials comprise graphene hybrid materials.

28. The method of claim 27, wherein the graphene hybrid materials are selected from the group consisting of graphene-carbon nanotube hybrid materials, graphene-carbon onion hybrid materials, graphene-carbon shell hybrid materials, graphene-boron nitride hybrid materials, graphene-carbon nanotube-carbon shell hybrid materials, graphene-boron nitride nanotube-carbon shell hybrid materials, and combinations thereof.

29. The method of claim 27, wherein the graphene hybrid materials comprise graphene-carbon nanotube-carbon shell hybrid materials.

30. The method of claim 1, wherein the plurality of connected units of the three-dimensional material are associated with one another through covalent bonds.

31. The method of claim 1, wherein the plurality of connected units of the three-dimensional material comprise connected units that are merged seamlessly with one another.

32. The method of claim 1, wherein the three-dimensional material comprises a foam-like structure.

33. The method of claim 1, wherein the three-dimensional material comprises a porous structure.

34. The method of claim 1, wherein the three-dimensional material comprises a porosity of more than about 80%.

35. The method of claim 1, wherein the three-dimensional material comprises pore diameters between about 1 nm to about 500 nm.

36. The method of claim 1, wherein the three-dimensional material comprises pore diameters between about 1 nm to about 10 nm.

37. The method of claim 1, wherein the three-dimensional material comprises surface areas ranging from about 50 m²/g to about 2,500 m²/g.

38. The method of claim 1, further comprising a step of controlling the shape of the three-dimensional material.

39. The method of claim 38, wherein the shape of the three-dimensional material is controlled by adjusting or selecting the shape of the catalytic material.

40. The method of claim 1, further comprising a step of controlling the porosity of the three-dimensional material.

41. The method of claim 40, wherein the porosity of the three-dimensional material is controlled by adjusting or selecting the porosity of the catalytic material.

42. The method of claim 40, wherein the porosity of the three-dimensional material is controlled by adjusting the weight pressure during the combining step,
wherein increasing the weight pressure reduces the porosity of the three-dimensional material, and
wherein decreasing the weight pressure increases the porosity of the catalytic material.

43. The method of claim 1, further comprising a step of incorporating the three-dimensional material as a component of an energy storage device.

44. The method of claim 43, wherein the three-dimensional material is utilized as an electrode in the energy storage device.

45. The method of claim 43, wherein the energy storage device is selected from the group consisting of capacitors, batteries, photovoltaic devices, photovoltaic cells, transistors, current collectors, fuel cell devices, water-splitting devices, and combinations thereof.

46. A three-dimensional material comprising:
a plurality of connected units,
wherein the plurality of connected units are on surfaces and internal cavities of the three-dimensional material.

47. The three-dimensional material of claim 46, wherein the connected units are selected from the group consisting of graphene, carbon shells, phosphorenes, boron nitrides, metal layers, carbon nanotubes, polymers, graphene nanoribbons, boron nitride nanotubes, chalcogenide nanotubes, metal chalcogenide nanotubes, nanoparticles, nanorods, nanowires, carbon onions, hybrid materials thereof, composites thereof, and combinations thereof.

48. The three-dimensional material of claim 46, wherein the plurality of connected units of the three-dimensional material comprise graphene.

49. The three-dimensional material of claim 48, wherein the graphene is selected from the group consisting of monolayer graphene, bilayer graphene, multilayer graphene, polycrystalline graphene, pristine graphene, single-crystal graphene, graphite, doped graphene, graphene oxide, functionalized graphene, and combinations thereof.

50. The three-dimensional material of claim 46, wherein the plurality of connected units of the three-dimensional material comprise metal layers.

51. The three-dimensional material of claim 50, wherein the metal layers comprise MXₙ,
wherein M is selected from the group consisting of Mo, W, Bi, Hf, Ga, Ge, Ta, Sn, Zn, Cd, Pb, B, Nb, Zr, Ti, W, Nb, Si and combinations thereof;
wherein X is selected from O, C, S, N, Se, Te, and combinations thereof; and
wherein n is 1, 2 or 3.

52. The three-dimensional material of claim 46, wherein the plurality of connected units of the three-dimensional material comprise hybrid materials.

53. The three-dimensional material of claim 52, wherein the hybrid materials comprise graphene hybrid materials.

54. The three-dimensional material of claim 53, wherein the graphene hybrid materials are selected from the group consisting of graphene-carbon nanotube hybrid materials, graphene-carbon onion hybrid materials, graphene-carbon shell hybrid materials, graphene-boron nitride hybrid materials, graphene-carbon nanotube-carbon shell hybrid materials, graphene-boron nitride nanotube-carbon shell hybrid materials, and combinations thereof.

55. The three-dimensional material of claim 53, wherein the graphene hybrid materials comprise graphene-carbon nanotube-carbon shell hybrid materials.

56. The three-dimensional material of claim 46, wherein the plurality of connected units of the three-dimensional material are associated with one another through covalent bonds.

57. The three-dimensional material of claim 46, wherein the plurality of connected units of the three-dimensional material comprise connected units that are merged seamlessly with one another.

58. The three-dimensional material of claim 46, wherein the three-dimensional material comprises a foam-like structure.

59. The three-dimensional material of claim 46, wherein the three-dimensional material comprises a porous structure.

60. The three-dimensional material of claim 46, wherein the three-dimensional material comprises a porosity of more than about 80%.

61. The three-dimensional material of claim 46, wherein the three-dimensional material comprises pore diameters between about 1 nm to about 500 nm.

62. The three-dimensional material of claim 46, wherein the three-dimensional material comprises pore diameters between about 1 nm to about 10 nm.

63. The three-dimensional material of claim 46, wherein the three-dimensional material comprises surface areas ranging from about 50 m²/g to about 2,500 m²/g.

64. The three-dimensional material of claim 46, wherein the three-dimensional material is utilized as an electrode in an energy storage device.

65. The three-dimensional material of claim 64, wherein the energy storage device is selected from the group consisting of capacitors, batteries, photovoltaic devices, photovoltaic cells, transistors, current collectors, fuel cell devices, water-splitting devices, and combinations thereof.
